(19) United States
(12) Patent Application Publication
(10) Pub. No.: US 2026/0361860 A1
(43) Pub. Date: Nov. 12, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 19/724,668

(22) Filed: Jun. 29, 2026

Related U.S. Application Data
(63) Continuation of application No. PCT/CN2024/143361, filed on Dec. 27, 2024.

(30) Foreign Application Priority Data
Dec. 29, 2023 (WO) PCT/CN2023/143486

(51) Int. Cl. H04N 19/11; H04N 19/593; H04N 19/70

(52) U.S. Cl. CPC H04N 19/11; H04N 19/593; H04N 19/70

(57) ABSTRACT

Embodiments of the disclosure provide a solution for video processing. A method for video processing is proposed. The method includes: determining, for a conversion between a current video unit of a video and a bitstream of the video, that a plurality of fusion modes are allowed to fuse a first prediction with at least one further prediction; and performing the conversion based on the plurality of fusion modes.

### CROSS-REFERENCE TO RELATED APPLICATIONS

This application is a continuation of International Application No. PCT/CN2024/143361, filed on Dec. 27, 2024, which claims the benefit of International Application No. PCT/CN2023/143486, filed on Dec. 29, 2023. The entire contents of these applications are hereby incorporated by reference in their entireties.

### FIELDS

Embodiments of the present disclosure relates generally to video processing techniques, and more particularly, to cross-component prediction (CCP) for inter and intra coding in video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video unit of a video and a bitstream of the video, that a plurality of fusion modes are allowed to fuse a first prediction with at least one further prediction; and performing the conversion based on the plurality of fusion modes. Compared with the conventional solution, the method in accordance with the first aspect of the present disclosure can improve the coding performance by using the plurality of fusion modes.

In a second aspect, another method for video processing is proposed. The method comprises: determining, for a conversion between a current video unit of a video and a bitstream of the video, a prediction based on a fusion process of blending a local-boosting cross-component prediction (LBCCP) coded prediction and a non-LBCCP coded prediction; and performing the conversion based on the prediction. Compared with the conventional solution, the method in accordance with the second aspect of the present disclosure can improve the coding performance by performing the fusion process.

In a third aspect, another method for video processing is proposed. The method comprises: inserting, for a conversion between a video unit of a video and a bitstream of the video, a low pass filtered cross-component prediction (CCP) candidate to a candidate list, wherein the candidate list is at least one of: a CCP list or a fusion candidate list; and performing the conversion based on the candidate list. Compared with the conventional solution, the method in accordance with the second aspect of the present disclosure can improve the coding performance by using the candidate list.

In a fourth aspect, an apparatus for video processing is proposed. The apparatus comprises a processor and a non-transitory memory with instructions thereon. The instructions upon execution by the processor, cause the processor to perform a method in accordance with the first, second, or third aspect of the present disclosure.

In a fifth aspect, a non-transitory computer-readable storage medium is proposed. The non-transitory computer-readable storage medium stores instructions that cause a processor to perform a method in accordance with the first, second, or third aspect of the present disclosure.

In a sixth aspect, another non-transitory computer-readable recording medium is proposed. The non-transitory computer-readable recording medium stores a bitstream of a video which is generated by a method performed by an apparatus for video processing. The method comprises: determining that a plurality of fusion modes are allowed to fuse a first prediction with at least one further prediction; and generating the bitstream based on the plurality of fusion modes.

In a seventh aspect, another non-transitory computer-readable recording medium is proposed. The non-transitory computer-readable recording medium stores a bitstream of a video which is generated by a method performed by an apparatus for video processing. The method comprises: determining a prediction based on a fusion process of blending a local-boosting cross-component prediction (LBCCP) coded prediction and a non-LBCCP coded prediction; and generating the bitstream based on the prediction.

In an eighth aspect, another non-transitory computer-readable recording medium is proposed. The non-transitory computer-readable recording medium stores a bitstream of a video which is generated by a method performed by an apparatus for video processing. The method comprises: inserting a low pass filtered cross-component prediction (CCP) candidate to a candidate list, wherein the candidate list is at least one of: a CCP list or a fusion candidate list; and generating the bitstream based on the candidate list.

In a ninth aspect, a method for storing a bitstream of a video is proposed. The method comprises: determining that a plurality of fusion modes are allowed to fuse a first prediction with at least one further prediction; generating the bitstream based on the plurality of fusion modes; and storing the bitstream in a non-transitory computer-readable recording medium.

In a tenth aspect, a method for storing a bitstream of a video is proposed. The method comprises: determining a prediction based on a fusion process of blending a local-boosting cross-component prediction (LBCCP) coded prediction and a non-LBCCP coded prediction; generating the bitstream based on the prediction; and storing the bitstream in a non-transitory computer-readable recording medium.

In an eleventh aspect, a method for storing a bitstream of a video is proposed. The method comprises: inserting a low pass filtered cross-component prediction (CCP) candidate to a candidate list, wherein the candidate list is at least one of: a CCP list or a fusion candidate list; generating the bitstream based on the candidate list; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an illustration of the effect of the slope adjustment parameter “u”, where the left is a model created with the current CCLM, and the right is a model updated as proposed;

FIG. 5 illustrates neighbouring blocks (L, A, BL, AR, AL) used in the derivation of a general MPM list;

FIG. 6 illustrates neighboring reconstructed samples used for DIMD chroma mode;

FIG. 7 illustrates an intra template matching search area used;

FIG. 8 illustrate the use of IntraTMP block vector for IBC block;

FIG. 9A and FIG. 9B illustrate the division method for angular modes, respectively;

FIG. 10 illustrates an extended MRL candidate list;

FIG. 11 illustrates an illustration of the template area;

FIG. 12 illustrates spatial part of the convolutional filter;

FIG. 13 illustrates a reference area (with its paddings) used to derive the filter coefficients;

FIG. 14 illustrates four Sobel based gradient patterns for GLM;

FIG. 15 illustrates non-downsampled luma samples;

FIG. 16 illustrates a reference area for BVG-CCCM;

FIG. 17 illustrates spatial samples used for GL-CCCM;

FIG. 18 illustrates various downsampling filters used in cross-component models;

FIG. 19 illustrates filter on samples of MM-CCLM/MM-CCCM;

FIG. 20 illustrates spatial GPM candidates;

FIG. 21 illustrates a GPM template;

FIG. 22 illustrates a GPM blending;

FIG. 23 illustrates a transform selection process for directional planar modes;

FIG. 24 illustrates luma blocks used to derive direct block vector;

FIG. 25A to FIG. 25C illustrate examples of prediction for different positions in the current block, respectively;

FIG. 26 illustrates the defined three types of reconstructed areas include thirteen columns or rows of reconstructed pixels;

FIG. 27 illustrates the defined three types of filter shapes have fifteen inputs and generate one output;

FIG. 28A to FIG. 28C illustrate examples of prediction for different positions in the current block, respectively;

FIG. 29 illustrates the proposed method on the decoder;

FIG. 30 illustrates luma samples L0, . . . , L5 in relation to the chroma sample C;

FIG. 31 illustrates reference area for BVG-CCCM;

FIG. 32 illustrates spatial part of the convolutional filter;

FIG. 33 illustrates locations used for block vector derivation from co-located luma block;

FIG. 34 illustrates a flowchart of a method for video processing in accordance with embodiments of the present disclosure;

FIG. 35 illustrates a flowchart of a method for video processing in accordance with embodiments of the present disclosure;

FIG. 36 illustrates a flowchart of a method for video processing in accordance with embodiments of the present disclosure; and

FIG. 37 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

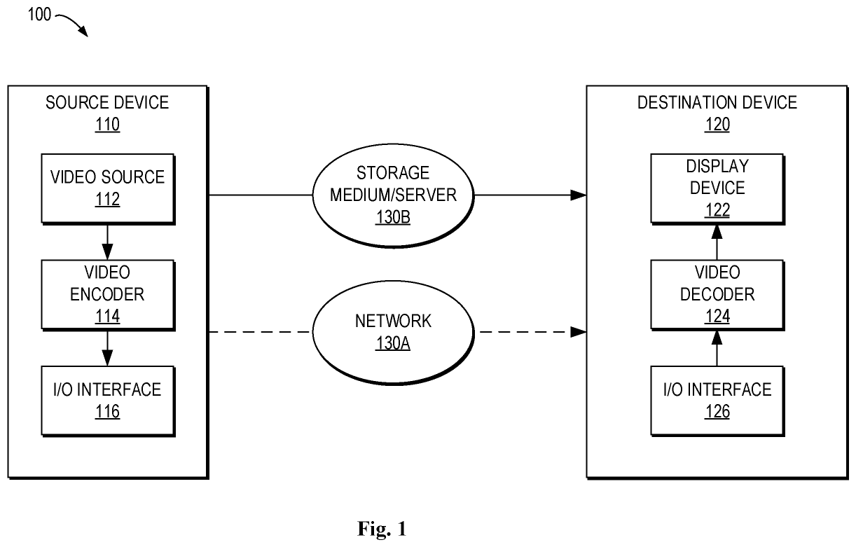

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

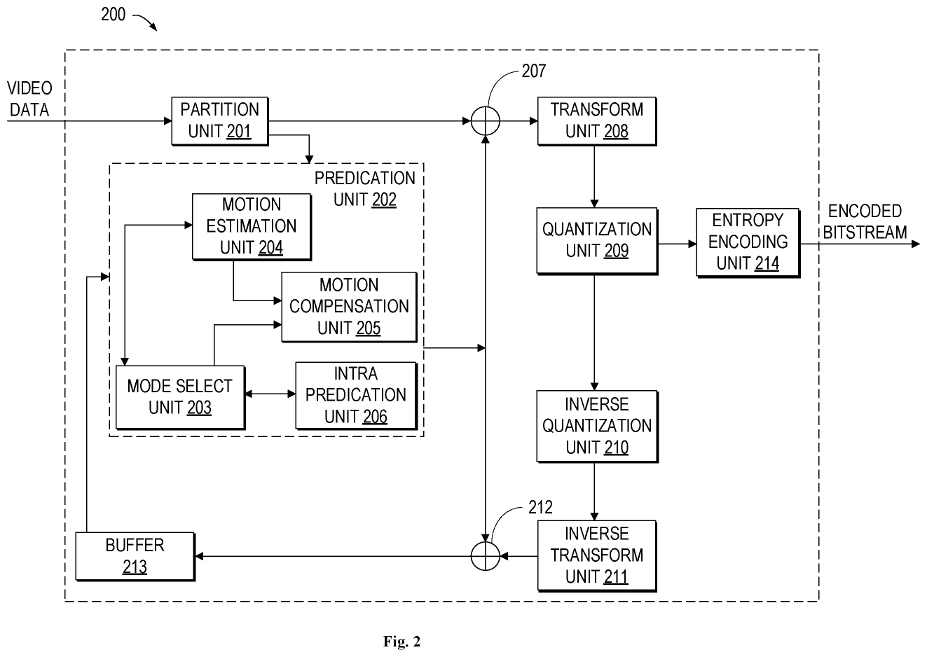

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to are construction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

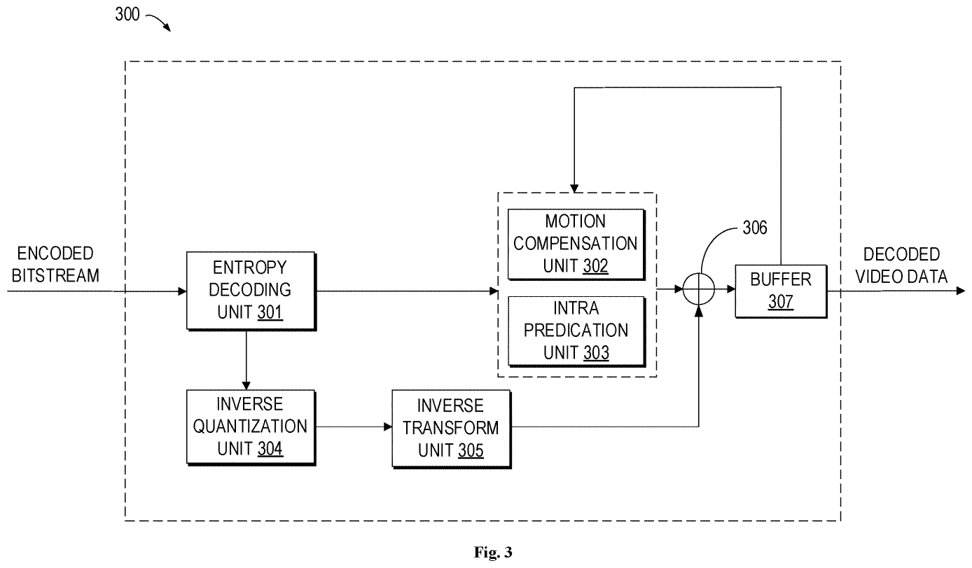

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 Brief Summary

The present disclosure is related to video coding technologies. Specifically, it is about the usage of cross-component prediction in image/video coding. It may be applied to the existing video coding standard like HEVC, VVC, and etc. It may be also applicable to future video coding standards or video codec.

### 2 Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-Model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:
chromaVal=a*lumaVal+b

An adjustment “u” to the slope parameter is signaled to update the model to the following form:

chromaVal=a′*lumaVal+b′

where
a′=a+u
b′=b−u*yr.

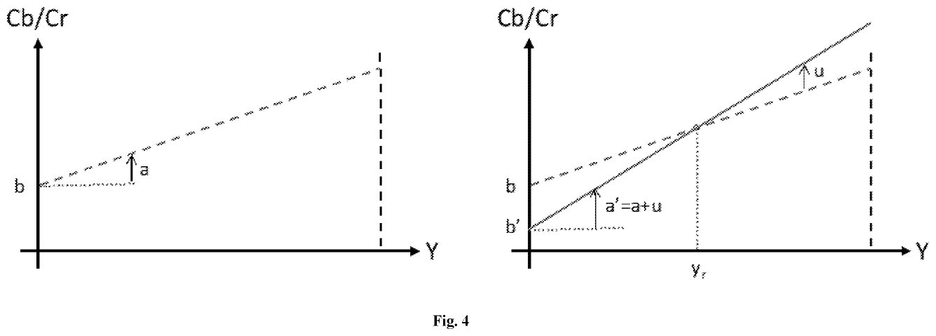

With this selection the mapping function is tilted or rotated around the point with luminance value yᵣ. The average of the reference luma samples used in the model creation as yᵣ in order to provide a meaningful modification to the model. FIG. 4 illustrates the process.

FIG. 4 illustrates the effect of the slope adjustment parameter “u”. Left: model created with the current CCLM. Right: model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied. The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Primary and Secondary MPM

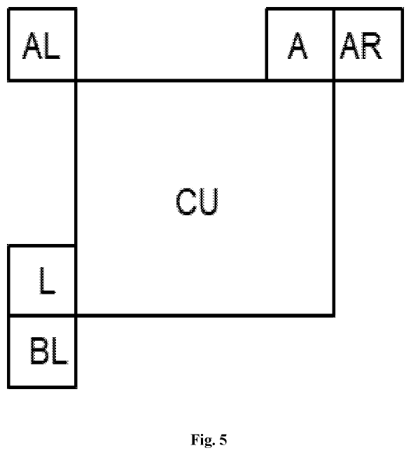

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 5, and DIMD modes which are sorted in ascending order of SAD cost. Up to 5 modes with the smallest SAD cost are added. The SAD cost is computed between the prediction and the reconstruction samples of the template. The sorted directional modes with added offset are added into the general MPM list, and then the default modes, until the general MPM list with 22 entries is constructed.

If a CU block is vertically oriented, the order of neighbouring blocks is A, L, BL, AR, AL; otherwise, it is L, A, BL, AR, AL.

FIG. 5 illustrates neighbouring blocks (L, A, BL, AR, AL) used in the derivation of a general MPM list.

MPM list is equally divided into four groups and the group index is parsed first. Then, a mode index is further parsed to indicate which mode in the selected group is used.

### 2.1.4 Reference Sample Interpolation and Smoothing for Intra-Prediction

The 4-tap cubic interpolation is replaced with a 6-tap cubic interpolation filter, for the derivation of predicted samples from the reference samples.

For reference sample filtering, a 6-tap gaussian filter is applied for larger blocks (W>=32 and
H>=32), existing VVC 4-tap gaussian interpolation filter is applied otherwise. The extended intra reference samples are derived using the 4-tap interpolation filter instead of the nearest neighbor rounding.

### 2.1.5 Decoder Side Intra Mode Derivation (DIMD)

When DIMD is applied, up to five intra modes are derived from the reconstructed neighbor samples, and those five predictors are combined with the planar mode predictor with the weights derived from the histogram of gradients. The division operations in weight derivation are performed utilizing the same lookup table (LUT) based integerization scheme used by the CCLM. For example, the division operation in the orientation calculation

Orient=G_{y}/Gₓ

is computed by the following LUT-based scheme:
x=Floor(Log 2(Gx))
normDiff=((Gx<<4)>>x) & 15
x+=(3+(normDiff !=0)?1:0)
Orient=(Gy*(DivSigTable[normDiff]|8)+(1<<(x−1)))>>x
   where
DivSigTable[16]={0, 7, 6, 5, 5, 4, 4, 3, 3, 2, 2, 1, 1, 1, 1, 0}.

For a block of size W×H, the weight for each of the five derived modes is modified if the one the above or left histogram magnitudes is twice larger than the other one. In this case, the weights are location dependent and computed as follows:

If the above histogram is twice the left, then:

$${w}_{i} ( x , y ) = {wDimd}_{i} + {Δ}_{i} - 2 {Δ}_{i} \frac{y}{( H - 1 )} .$$

If the left histogram is twice the above, then:

$${w}_{i} ( x , y ) = {wDimd}_{i} + {Δ}_{i} - 2 {Δ}_{i} \frac{x}{( W - 1 )} ,$$

where wDimdᵢ is the unmodified uniform weight of the DIMD, Δᵢ is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

Finally, note the region of neighboring reconstructed samples used for computing the histogram of gradients is modified, depending on reconstructed samples availability. The region of decoded reference samples of current W×H luma CB is extended towards the above-right side if available, up to W additional columns. It is extended towards the bottom-left side if available, up to H additional rows.

### 2.1.5.1 DIMD Chroma Mode

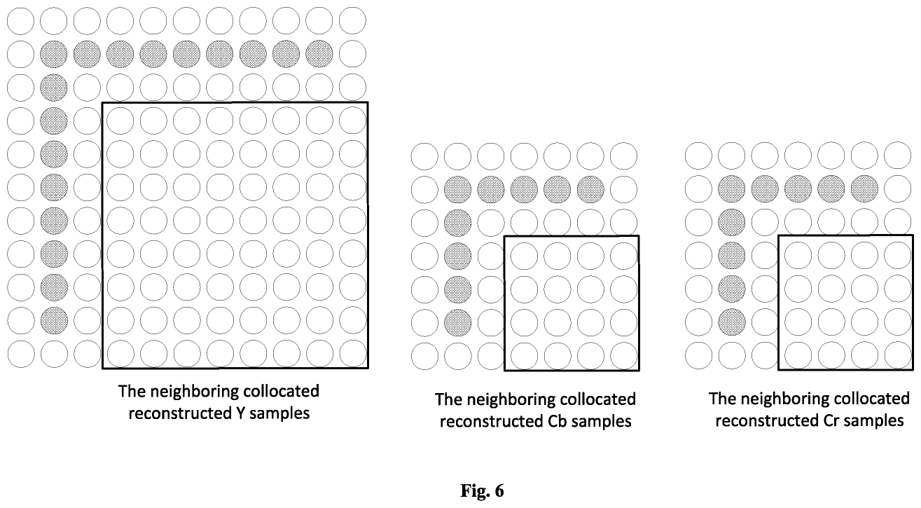

The DIMD chroma mode uses the DIMD derivation method to derive the chroma intra prediction mode of the current block based on the neighboring reconstructed Y, Cb and Cr samples in the second neighboring row and column as shown in FIG. 6. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block. FIG. 6 illustrates neighboring reconstructed samples used for DIMD chroma mode.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

Finally, the luma region of reconstructed samples used for computing the histogram of gradients for chroma DIMD mode is modified. For a W×H pair of chroma CBs to predict, to build the histogram of gradients associated to the collocated luma CB, the pairs of a vertical gradient and a horizontal gradient are extracted from the second and third lines in this luma CB instead of being extracted from the regular set of DIMD decoded reference samples around this luma CB.

### 2.1.6 Fusion of Chroma Intra Prediction Modes

In ECM, two chroma intra prediction signals can be fused together. One of the two chroma intra prediction signals is predicted using one of the DM mode, DIMD chroma mode and the four default modes (non-LM mode). The other chroma intra prediction signal is predicted using cross-component linear prediction modes (LM mode). Two different methods are supported.

In the first method, the LM mode can be either MM-CCLM or MM-CCCM, and the final predictor is derived as follows:

pred_{c}(i,j)=(w0×pred0(i,j)+w1×pred1(i,j)+(1«(shift−1)))»shift

where pred0(i,j) is the predictor obtained by applying the non-LM mode, pred1(i,j) is the predictor obtained by applying the LM mode and pred_{c}(i,j) is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}. Two template costs are calculated by fusing the angular chroma prediction with MM-CCLM or MM-CCCM, respectively, and the one of the two CCPs which provides a smaller template cost is utilized to derive pred1.

In the second method, the LM mode can be either MMLM or CCLM mode, and the final predictor is derived as follows:

$${pred}_{C} ( i , j ) = {α}_{0} \times pred 0 ( i , j ) + {α}_{1} \times {rec}_{L}^{′} ( i , j ) + {α}_{2} + β$$

where pred0(i,j) is the predictor obtained by applying the non-LM mode,

$${rec}_{L}^{′} ( i , j )$$

is the set of downsampled reconstructed luma samples at co-located positions and pred_{c}(i,j) is the final predictor of the current chroma block. β is a fixed value and is set equal to 512 for 10-bit content. The three weights, α₀, α₁ and α₂ are derived from the adjacent luma and chroma samples using the same LDL derivation method as in CCCM.

For the syntax design, one index is signaled to indicate whether fusion is applied and which method is used. It is noted that for I slices, the non-LM mode can be DM mode, DIMD chroma mode and the four default modes. For non-I slices, only DIMD chroma mode is allowed to be fused with LM modes.

| Index value | Name |
|---|---|
| 0 | No fusion |
| 1 | First method |
| 2 | Second method with CCLM |
| 3 | Second method with MMLM |

### 2.1.7 Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

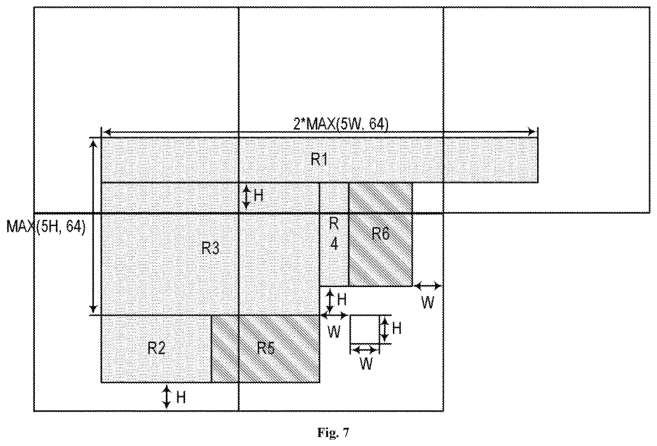

The prediction signal is generated by matching the L-shaped, Top-only or Left-Only causal neighbor of the current block with another block in a predefined search area in FIG. 7. There are 6 predefined search areas, i.e., R1 to R6 which contain the reconstructed samples from the top and left CTUs as well as part of the reconstructed samples within the current CTU that are located above, left, bottom-left and top-right to the current block.

Sum of absolute differences (SAD) is used as a cost function.

A given search order of the 6 regions is utilized, i.e., R4, R5, R6, R1, R2, and R3. Within each region, the decoder constructs a candidate list of up to “19” template matching block vectors that are ranked in ascending order according to the template cost (SAD). The following modes are supported:
1—Single predictor: A single predictor is selected from the candidate list.
2—Fusion of multiple predictors: multiple predictors are blended multiple to derive the final prediction block. The blending weights are either computed from the template matching cost of each predictor, or with Wiener-filter based weight derivation method.
3—Sub-pel precision: When single predictor is used, sub-pel precion can be used with ½-pel precision, ¼-pel precision and ¾-pel precision, each with 8 possible directions.
4— linear filter model: A linear filter can be learned between the reference template and current template and be applied the linear model to reference block. This mode can be used for single predictor when sub-pel precision is not used.

The dimensions of all regions (SearchRange_w, SearchRange_h) are set proportional to the block dimension (BlkW, BlkH) to have a fixed number of SAD comparisons per pixel. That is:

SearchRange_w=min(64,a*BlkW)

SearchRange_h=min(64,a*BlkH)

Where ‘α’ is a constant that controls the gain/complexity trade-off. In practice, ‘a’ is equal to 5.

FIG. 7 illustrates intra template matching search area used.

To speed-up the template matching process, the search range of all search regions is subsampled by a factor of 3. After finding the best match, a refinement process is performed. The refinement is done via a second template matching search around the best match with a reduced range.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.1.7.1 IntraTMP Derived Block Vector Candidates for IBC

In this method block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

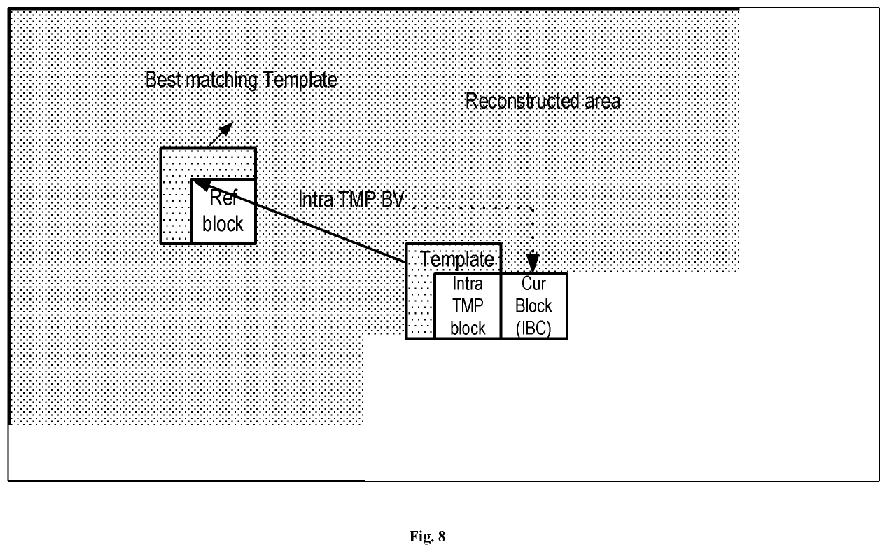

IntraTMP block vector is stored in the IBC block vector buffer and, the current IBC block can use both IBC BV and IntraTMP BV of neighbouring blocks as BV candidate for IBC BV candidate list as shown in FIG. 8.

IntraTMP block vectors are added to IBC block vector candidate list as spatial candidates.

### 2.1.8 Fusion for Template-Based Intra Mode Derivation (TIMD)

For each intra prediction mode in MPMs, as well as the wide-angle modes if the above-right and/or bottom-left reference samples are available, SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

costMode2<2*costModel.

If this condition is true, the fusion is applied, otherwise the only model is used.

Weights of the modes are computed from their SATD costs as follows:

weight1=costMode2/(costMode1+costMode2),

weight2=1−weight1.

The division operations are conducted using the same lookup table (LUT) based integerization scheme used by the CCLM.

### 2.1.9 Intra Prediction Fusion

This intra prediction method derives predicted samples as a weighted combination of multiple predictors generated from different reference lines. In this process multiple intra predictors are generated and then fused by weighted averaging. The process of deriving the predictors to be used in the fusion process is described as follows:
For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=3/4 and w₁=1/4.
For TIMD mode with blending, pₗᵢₙₑ is used for the first mode (w₀=1, w₁=0) and pₗᵢₙₑ₊₁ is used for the second mode (w₀=0, w₁=1).
For DIMD mode with blending, the number of predictors selected for a weighted average is increased from 3 to 6.

Intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

2.1.10 Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

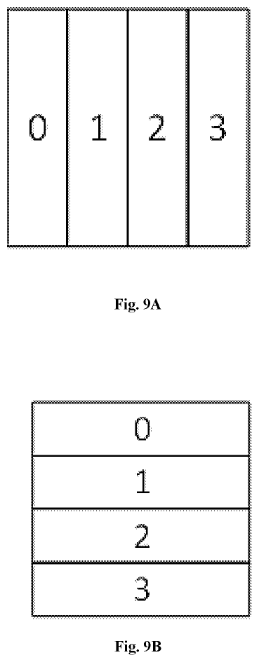

In addition, it is also proposed to modify the weights (wIntra, wInter) for the two tests if the derived intra prediction mode is an angular mode. For near-horizontal modes (2<=angular mode index<34), the current block is vertically divided as shown in FIG. 9A; for near-vertical modes (34<=angular mode index<=66), the current block is horizontally divided as shown in FIG. 9B.

The (wIntra, wInter) for different sub-blocks are shown in Table 1.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.11 Extended Multiple Reference Line (MRL) List

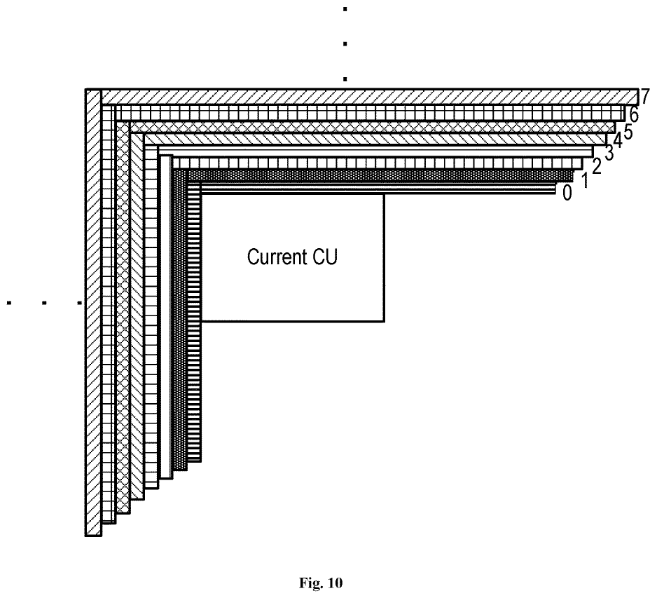

MRL list in VVC is extended to include more reference lines for intra prediction. The extended reference line list consists of line indices {1, 3, 5, 7, 12} as shown FIG. 10. For template-based intra mode derivation (TIMD), instead of the full MRL candidate list, only the first two reference line candidates, i.e., {1, 3}, are used.

### 2.1.12 Template-Based Multiple Reference Line Intra Prediction

Template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode.

The TMRL mode extends reference line candidate list and the intra-prediction-mode candidate list. The extended reference line candidate list is {1, 3, 5, 7, 12}. The restriction on the top CTU row is unchanged. The size of the intra-prediction-mode candidate list is 10. The construction of the intra-prediction-mode candidate list is similar to MPM except the PLANAR mode is excluded from the intra-prediction-mode candidate list, DC mode is added after 5 neighboring PUs' modes and DIMD modes if its not included and the angular modes with delta angles from ±1 to ±4 (compared the existing angular modes in the intra-prediction-mode candidate list) are added. The precision of angular prediction is extended from 65 to 129. Additionally non-adjacent positions are added as candidates in constructing the intra candidate list. If the neighbouring or non-adjacent blocks are coded with SGPM or GPM modes, the intra modes of the blocks are replaced by the partitioning angles.

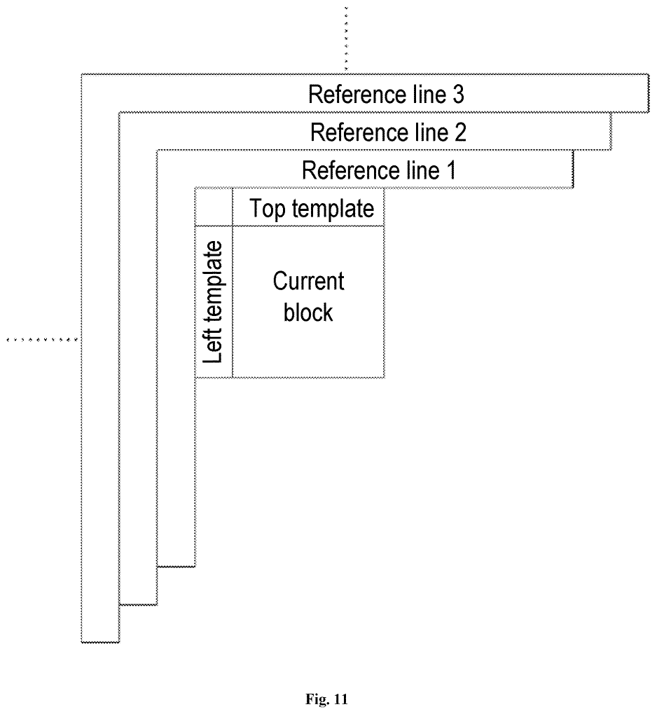

The TMRL candidate is constructed as follows. There are 5×10=50 combinations of the extended reference line and the allowed intra-prediction modes for a block. Since the extended reference line starts from reference line 1, the area covered by reference line 0 is used for template matching. The SAD costs over the template area (see FIG. 11) are calculated between the predictions (generated by 50 combinations) and the reconstructions. The 20 combinations with the least SAD cost are selected in an ascending order to form the TMRL candidate list.

For TMR signalling instead of coding the reference line and the intra mode directly, an index to the TMRL candidate list is coded to indicate which combination of reference line and prediction mode is used for coding the current block.

### 2.1.13 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.13.1 Convolutional Filter

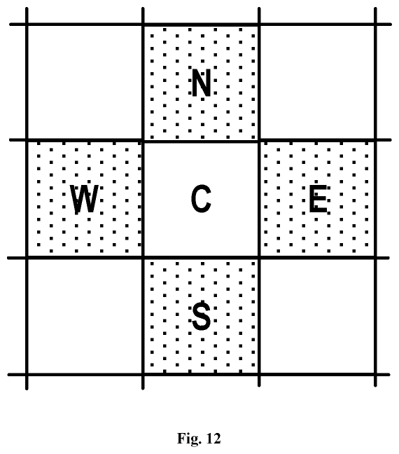

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated in FIG. 12.

FIG. 12 illustrates spatial part of the convolutional filter.

The nonlinear term P is represented as power of two of the center luma sample C and scaled to the sample value range of the content:

P=(C*C+midVal)>>bitDepth.

That is, for 10-bit content it is calculated as:

P=(C*C+512)>>10.

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

predChromaVal=c₀C+c₁N+c₂S+c₃E+c₄W+c₅P+c₆B.

### 2.1.13.2 Calculation of Filter Coefficients

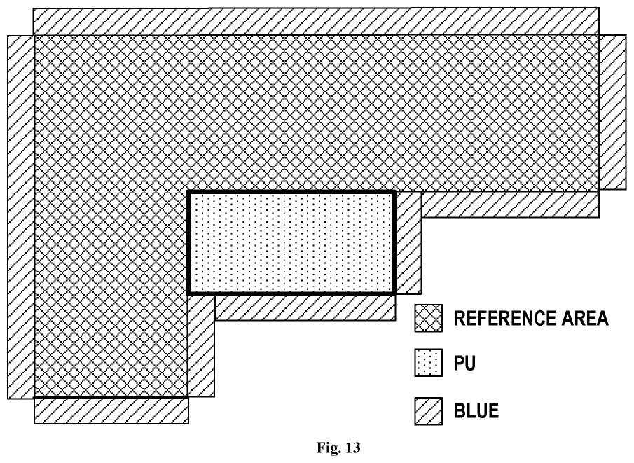

The filter coefficients cᵢ are calculated by minimising MSE between predicted and reconstructed chroma samples in the reference area. FIG. 13 illustrates the reference area which consists of 2 or 6 lines of chroma samples above and left of the PU. Whether to use 6 lines or 2 lines of neighbouring samples to derive the CCCM model parameters in the single model CCCM is determined by a template cost. Similarly, for the multi-model CCCM mode, the two candidates use 6 lines neighbouring luma samples or luma samples collocated to the current chroma block to derive mean values which separate samples into two groups. The cost is derived by applying the candidate CCP (either 2 or 6 lines) on a template, calculating the sum of absolute difference (SAD) between CCP predicted samples and reconstructed samples in the template.

Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:
C′=C−offsetLuma,
N′=N−offsetLuma,
S′=S−offsetLuma,
E′=E−offsetLuma,
W′=W−offsetLuma,
P′=nonLinear(C′),
B=midValue=1<<(bitDepth−1),
and the chroma value is predicted using the following equation, where offsetChroma is equal to offsetCr and offsetCb for Cr and Cb components, respectively:

predChromaVal=c₀C′+c₁N′+c₂S′+c₃E′+c₄W′+c₅P′+c₆B+offsetChroma.

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation are replaced with multiplication (with a scale factor) and shift operation, where scale factor and number of shifts are calculated based on denominator similar to the method used in calculation of CCLM parameters.

### 2.1.13.3 Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

C=α·G+β

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

C=α₀·G+α₁·L+α₂·β

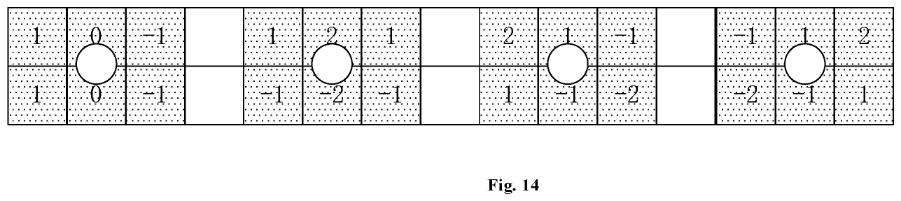

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.
Four gradient filters are enabled for the GLM, as illustrated in FIG. 14.

### 2.1.13.4 CCCM Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.13.5 CCCM Using Non-Downsampled Luma Samples

CCCM mode with 3×2 filter using non-downsampled luma samples is used, which consists of 6-tap spatial terms, four nonlinear terms and a bias term. The 6-tap spatial terms correspond to 6 neighboring luma samples (i.e., L₀, L₁, . . . , L₅) around the chroma sample (i.e., C) to be predicted, the four non-linear terms are derived from the samples L₀, L₁, L₂, and L₃ as shown in FIG. 15.

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 4} - offsetLuma )}^{2} + β )$$

$$≫ bitDepth ) + {α}_{10} \cdot β + offsetChroma$$

where αᵢ is the coefficient, β is the offset. Same to the existing CCCM design, up to 6 lines/columns of chroma samples above and left to the current CU are applied to derive the filter coefficients. The filter coefficients are derived based on the same LDL decomposition method used in CCCM. The proposed method is signaled as an additional CCCM model besides the existing one, when the CCCM is selected, one single flag is signaled and used for both two chroma components to indicate whether the default CCCM model or the proposed CCCM model is applied. Additionally, SPS signaling is introduced to indicate whether the CCCM using non-downsampled luma samples is enabled.

### 2.1.13.6 Block-Vector Guided CCCM (BVG-CCCM)

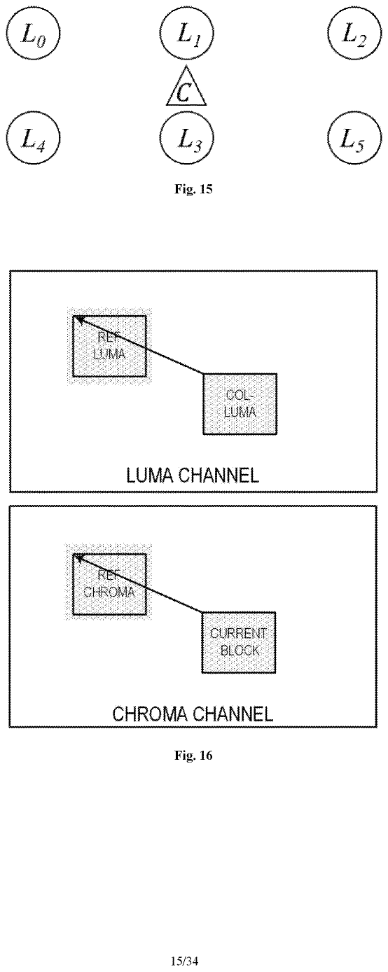

When the co-located luma prediction is coded with IBC or IntraTMP in Intra slices, the BVG-CCCM mode can be used. In this mode, the block vectors of the co-located luma blocks, coded in IBC or intraTMP modes, are used to determine the reference area for calculating the CCCM parameters. The prediction is performed using uses the calculated model parameters and co-located luma samples. FIG. 16 illustrates the reference area in BVG-CCCM method.

The BVG-CCCM mode uses an 11-tap filter for cross-component prediction as below:

predChromaVal=c₀C+c₁N+c₂S+c₃E+c₄W+c₅P(C)+c₆P(N)+c₇P(S)+c₈P(W)+c₉P(E)+c₁₀B.

The input to the spatial 5-tap component of the filter consists of a center (C) luma sample which is collocated with the chroma sample to be predicted and its above/north (N), below/south (S), left/west (W) and right/east (E) neighbors as illustrated in FIG. 12.

The nonlinear term P is represented as power of two of the corresponding luma sample and B is the bias term.

Similar to Direct Block Vector (DBV Sec. 2.1.13.6), five locations, in the collocated luma block area are scanned and the associated block vectors are then used for determining the reference area for parameter calculation in BVG-CCCM method.

### 2.1.13.7 Gradient and Location Based Convolutional Cross-Component Model (GL-CCCM)

This method maps luma values into chroma values using a filter with inputs consisting of one spatial luma sample, two gradient values, two location information, a nonlinear term, and a bias term. The GL-CCCM method uses gradient and location information instead of the 4 spatial neighbor samples used in the CCCM filter. The GL-CCCM filter used for the prediction is:

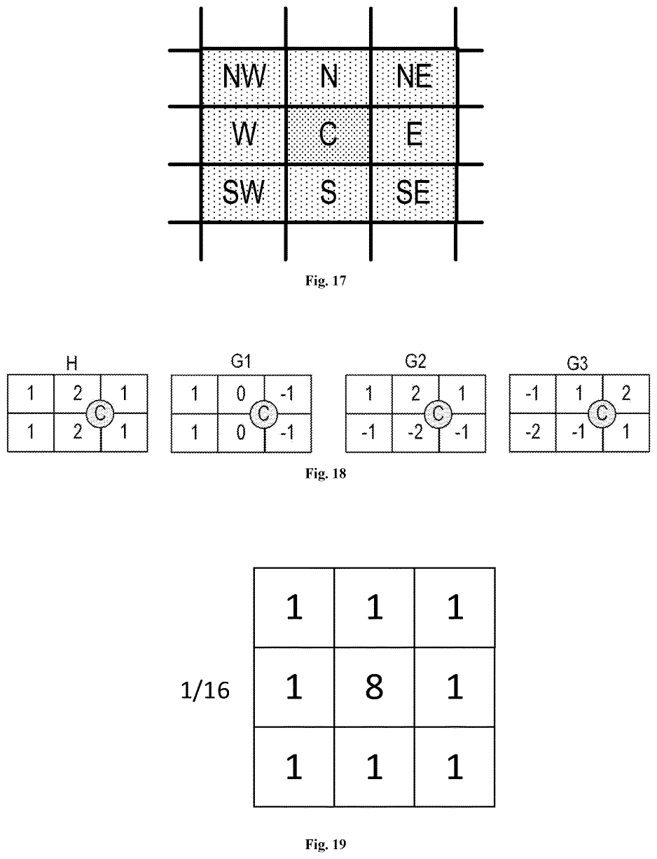

predChromaVal=c₀C+c₁G_{y}+c₂Gₓ+c₃Y+c₄X+c₅P+c₆B.

Where G_{y} and Gₓ are the vertical and horizontal gradients, respectively, and are calculated as FIG. 17:

G_{y}=(2N+NW+NE)−(2S+SW+SE),

Gx=(2W+NW+SW)−(2E+NE+SE).

Moreover, the Y and X are the spatial coordinates of the center luma sample.

The rest of the parameters are the same as CCCM tool. The reference area for the parameter calculation is the same as CCCM method.

The usage of the mode is signalled with a CABAC coded PU level flag. When it comes to signalling, GL-CCCM is considered a sub-mode of CCCM. That is, the GL-CCCM flag is only signalled if original CCCM flag is true.

Similar to the CCCM, GL-CCCM tool has 6 modes for calculating the parameters:
Single-model GL-CCCM from above and left templates.
Single-model GL-CCCM from above template.
Single-model GL-CCCM from left template.
Multi-model GL-CCCM from above and left templates.
Multi-model GL-CCCM from above template.
Multi-model GL-CCCM from left template.

The encoder performs SATD search for the 6 GL-CCCM modes along with the existing CCCM modes to find the best candidates for full RD tests.

2.1.13.8 CCCM with Multiple Downsampling Filters

Multiple downsampling filters are applied to a group of reconstructed luma samples in a CCCM. The linear combination of these downsampled reconstructed samples is multiplied by derived filter coefficients to form the final chroma predictor. The horizontal or vertical location of the center luma sample are also considered in the tested model. The cross-component models shown below are tested as additional CCCM modes with a mode index signalled in the bitstream:
(1) Model 1: predChroma=c0*H(C)+c1*G1(C)+c2*G2(C)+c3*G3(C)+c4*P(H(C))+c5*P(G1(C))+c6*P(G2(C))+c7*X+c8*Y+c9*B
(2) Model 2: predChroma=c0*H(C)+c1*H(W)+c2*H(E)+c3*G1(C)+c4*G1(W)+c5*G1(E)+c6*P(H(C))+c7*P(H(W))+c8*P(H(E))+c9*X+c10*B
(3) Model 3: predChroma=c0*H(C)+c1*H(NE)+c2*H(SW)+c3*G3(C)+c4*G3(NE)+c5*G3(SW)+c6*P(H(C))+c7*P(H(NE))+c8*P(H(SW))+c9*Y+c10*B
   where H(·), G1(·), G2(·), G3(·) are various downsampling filters as indicated in FIG. 18, C denotes the current chroma sample position, and N, S, W, E, NE, SW are the positions around C, cᵢ are filter coefficients, P and B are nonlinear term and bias term, and X and Y are the horizontal and vertical locations of the center luma sample with respect to the top-left coordinates of the block.

### 2.1.14 Local-Boosting Cross-Component Prediction (LBCCP)

Prediction samples of MM-CCLM/MM-CCCM can be filtered with neighbouring samples. As shown in FIG. 19, a 3×3 low-pass filter is applied to filter prediction samples generated by MM-CCLM/MM-CCCM. For a sample at a top/left boundary, the filtering window may involve neighbouring reconstructed samples. For inner samples, the filtering window only involves prediction samples, which may be padded. A flag is signaled to indicate whether filtering is applied or not for a block coded with MM-CCLM/MM-CCCM.

### 2.1.15 Cross-Component Prediction (CCP) Merge (a.k.a., Non-Local CCP) Mode

For chroma coding, a flag is signalled to indicate whether CCP mode (including the CCLM, CCCM, GLM and their variants) or non-CCP mode (conventional chroma intra prediction mode, fusion of chroma intra prediction mode) is used. If the CCP mode is selected, one more flag is signalled to indicate how to derive the CCP type and parameters, i.e., either from a CCP merge list or signalled/derived on-the-fly. a CCP merge candidate list is constructed from the spatial adjacent, temporal, spatial non-adjacent, history-based or shifted temporal candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighbouring template of the current block. More details are described below.

### Spatial Adjacent and Non-Adjacent Candidates

The positions and inclusion order of the spatial adjacent and non-adjacent candidates are the same as those defined in ECM for regular inter merge prediction candidates.

### Temporal and Shifted Temporal Candidates

Temporal candidates are selected from the collocated picture. The position and inclusion order of the temporal candidates are the same as those defined in ECM for regular inter merge prediction candidates. The shifted temporal candidates are also selected from the collocated picture. The position of temporal candidates is shifted by a selected motion vector which is derived from motion vectors of neighboring blocks.

### History-Based Candidates

A history-based table is maintained to include the recently used CCP models, and the table is reset at the beginning of each CTU row. If the current list is not full after including spatial adjacent and non-adjacent candidates, the CCP models in the history-based table are added into the list.

### Default Candidates

CCLM candidates with default scaling parameters are considered, only when the list is not full after including the spatial adjacent, spatial non-adjacent, or history-based candidates. If the current list has no candidates with the single model CCLM mode, the default scaling parameters are {0, 1/8, −1/8, 2/8, −2/8, 3/8, −3/8, 4/8, −4/8, 5/8, −5/8, 6/8}. Otherwise, the default scaling parameters are {0, the scaling parameter of the first CCLM candidate+{1/8, −1/8, 2/8, −2/8, 3/8, −3/8, 4/8, −4/8, 5/8, −5/8, 6/8}}.

A flag is signaled to indicate whether the CCP merge mode is applied or not. If CCP merge mode is applied, an index is signaled to indicate which candidate model is used by the current block. In addition, CCP merge mode is not allowed for the current chroma coding block when the current CU is coded by intra sub-partitions (ISP) with single tree, or the current chroma coding block size is less than or equal to 16.

2.1.16 Spatial Geometric partitioning mode (SGPM)

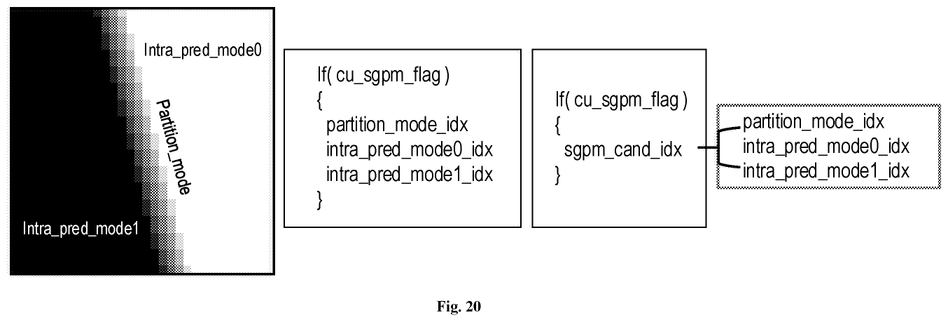

SGPM is an intra mode that resembles the inter coding tool of GPM, where the two prediction parts are generated from intra predicted process. In this mode, a candidate list is built with each entry containing one partition split and two intra prediction modes as shown in FIG. 20. 26 Partition Modes and 3 of Intra Prediction modes are used to form the combinations, the length of the candidate list is set equal to 16. The selected candidate index is signalled.

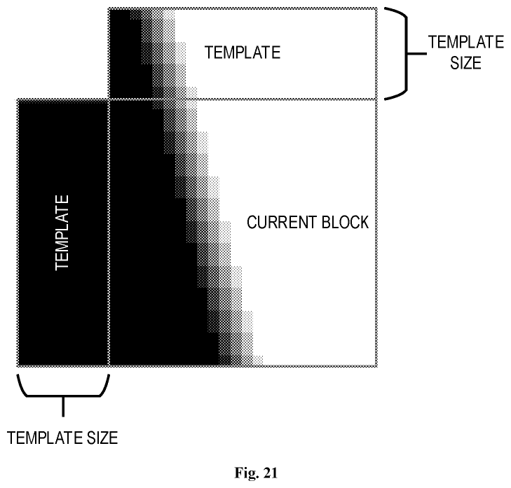

The list is reordered using template (FIG. 21) where SAD between the prediction and reconstruction of the template is used for ordering. The template size is fixed to 1.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width<=64, 4<=height<=64, width<height*8, height<width*8, width*height>=32.

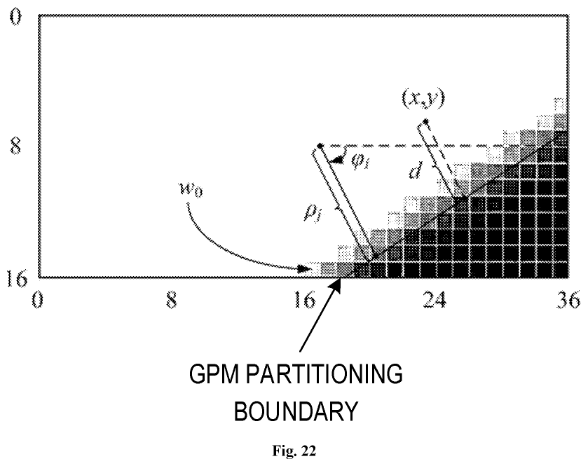

A PPS flag is coded to indicate whether no blending of two intra predictions is allowed. When this PPS flag is set to false, the following adaptive blending is also used for spatial GPM, where blending depth r shown in FIG. 22 is derived as follows:
If min(width, height)==4, 1/2 τ is selected.
else if min(width, height)==8, τ is selected.
else if min(width, height)==16, 2 τ is selected.
else if min(width, height)==32, 4 τ is selected.
else, 8 τ is selected.

Otherwise (the PPS flag is set to true), ¼ τ is always used for spatial GPM coded blocks to make sure no blending is used when SGPM block has partition angle completely horizontal or vertical, and much narrower blending width is used when SGPM block has other partition angles. It is noted that the flag is set to true in current Common Test Conditions (CTC) for the screen content videos.

### 2.1.17 Directional Planar Mode

Two additional planar modes where only the horizontal interpolation or only the vertical interpolation are used to obtain the predicted samples.

For planar horizontal mode, only the horizontal linear interpolation is performed based on the left reference sample and the top-right reference sample to predict the current sample as:

pred(x,y)=((W−1−x)*rec(−1,y)+(x+1)*rec(W,−1)+(W»1))» log₂(W).

For planar vertical mode, only the vertical linear interpolation is performed based on the above reference sample and the bottom-left reference sample to predict the current sample as:

pred(x,y)=((H−1−y)*rec(x,−1)+(y+1)*rec(−1,H)+(H»1))» log₂(H).

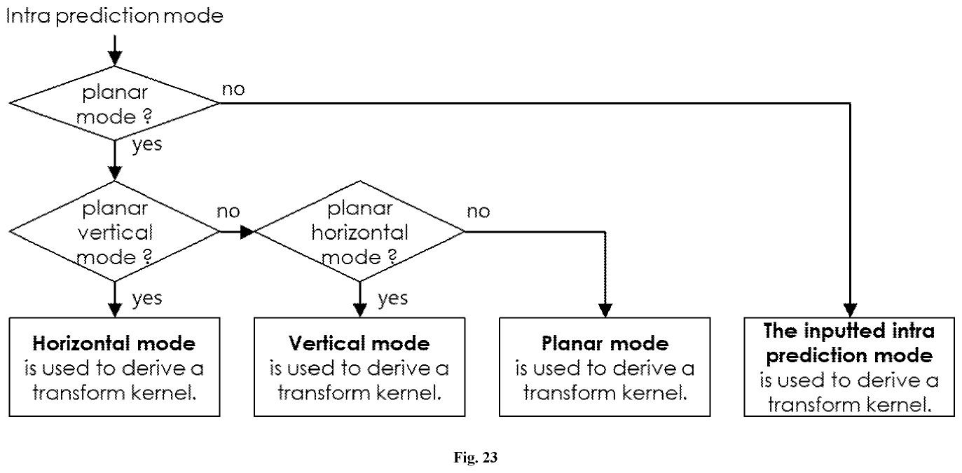

The transform kernel selection for planar horizontal and planar vertical mode is shown in FIG. 23. If an intra prediction mode of a current block is the planar vertical mode, the horizontal intra prediction mode is used to derive a transform kernel in MTS set and LENST set. Also, if an intra prediction mode of a current block is the planar horizontal mode, the vertical intra prediction mode is used to derive a transform kernel in MTS set and LFNST set.

### 2.1.18 Direct Block Vector for Chroma Block

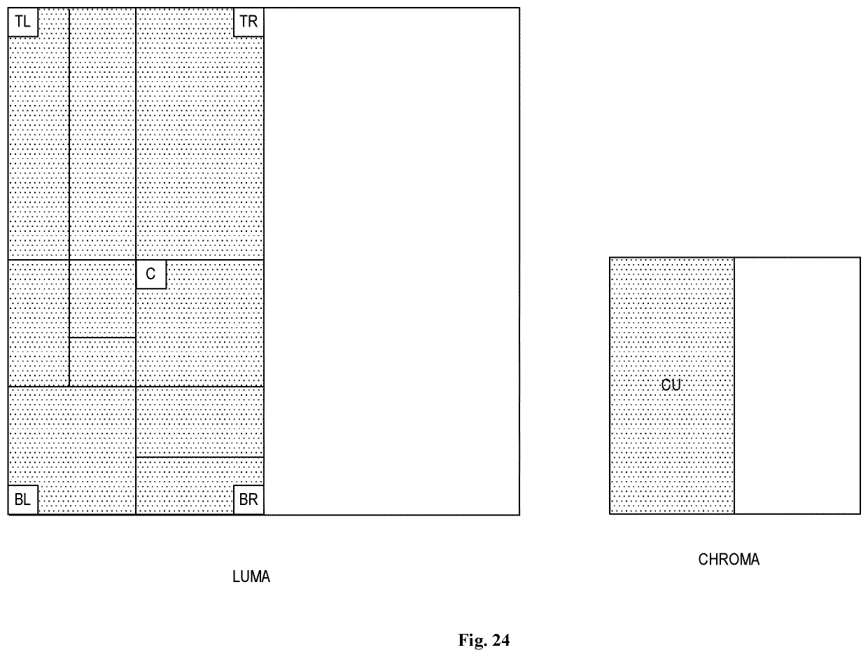

The direct block vector is used for chroma block in dual tree slices. When chroma dual tree is activated, a flag is signaled to indicate whether a chroma block is coded using IBC mode. If one of the luma blocks in five locations shown in FIG. 24 is coded with IBC or intraTMP mode, its block vector is scaled and is used as block vector for the chroma block. Template matching is used to perform block vector scaling.

### 2.1.18.1 Prediction of Current Block

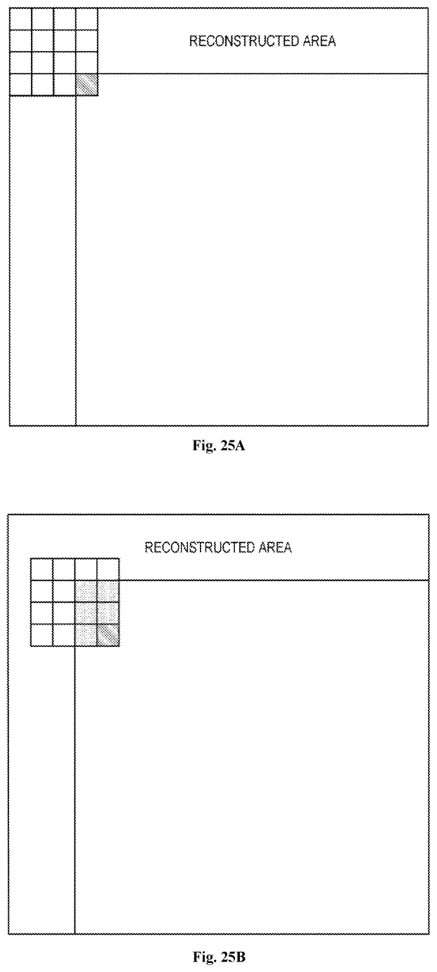

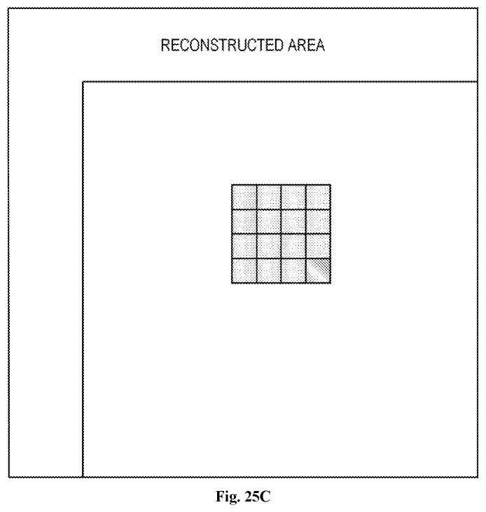

The EIP mode makes predictions for the current block position by position, as shown FIG. 25A to FIG. 25C. In addition, all inputs to EIP are reconstructed samples in FIG. 25A, partial inputs are reconstructed samples and partial inputs are predicted samples in FIG. 25B, and all inputs to EIP area predicted samples in FIG. 25C.

For the position located at top-left of the current block, the inputs to the EIP filter are reconstructed samples.

For the positions located along the boundaries of the current block, partial inputs to the EIP filter are reference samples, and partial inputs to the EIP filter are previously predicted samples.

For other positions in the current block, the inputs to the EIP filter are previously predicted samples.

To reduce the prediction error, the searched min and max values are applied to restrict the output range of each predicted value,

$${pred}_{( x , y )} = clip ( min , max , ( {\sum }_{i = 0}^{n} ( {c}_{i} \times ( {t}_{( x - xoffset , y - yoffset )} - mean ) ) ) + mean )$$

pred_{(x,y)} is the predicted value at (x, y) in the current block,
min, max are searched min and max values from the thirteen reconstructed columns and rows,
cᵢ is the i^{th} coefficient of the derived EIP filter,
t_{(x-xoffset,y-yoffset)} is reconstructed or predicted value used for the current position's prediction, mean is a value calculated by the DC prediction mode.

### 2.1.19 An Extrapolation Filter-Based Intra Prediction Mode (EFI Mode)

The proposed extrapolation filter-based intra prediction is processed in two steps. First, the extrapolation filter coefficients are obtained from the neighboring reconstructed pixels of the current block with a pre-determined template. Second, the extrapolation generates a predicted value position by position from top-left to bottom-right within the current block.

### 2.1.19.1 Searching Mean, Min, and Max Value

Similar to CCCM mode, a mean value should be removed when feeding the inputs to the EIP filter. The value of the DC mode for the current block is used as a mean value for EIP prediction. The min and max value are searched from reconstructed pixels in the reconstructed area with thirteen columns and thirteen rows.

### 2.1.19.2 Calculation of Filter Coefficients

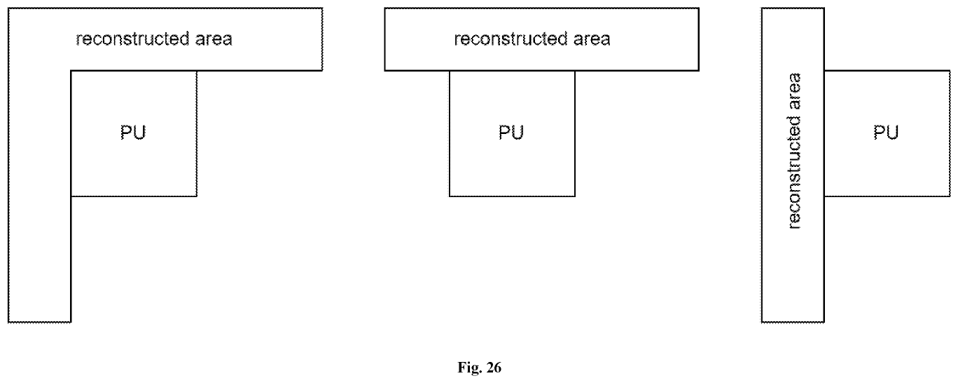

Three types of reconstructed areas and three filter shapes are proposed, as shown in FIG. 26. When the current block uses the proposed EIP mode for prediction, the decoder decodes the relevant syntax elements to determine the selected type of reconstructed area and filter shape for the current block.

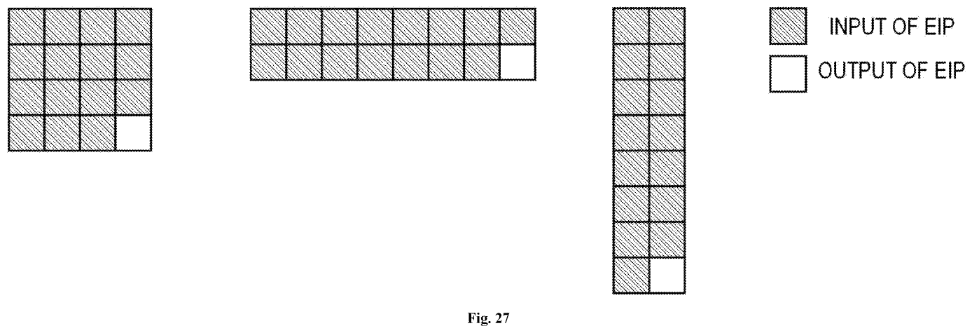

FIG. 27 illustrates the defined three types of filter shapes have fifteen inputs and generate one output.

The selected filter slides in the selected reconstructed area with a one-pixel step to collect input samples and output samples of EIP. The auto-correlation matrix and cross-correlation vector are constructed while removing the mean value from input samples and output samples. Then, the EIP coefficients are obtained by the same method in CCCM.

### 2.1.19.3 Prediction of Current Block

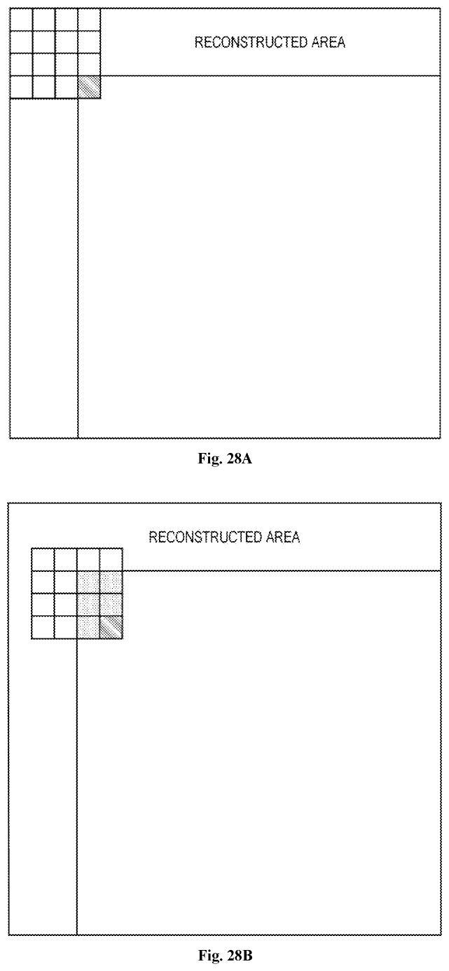

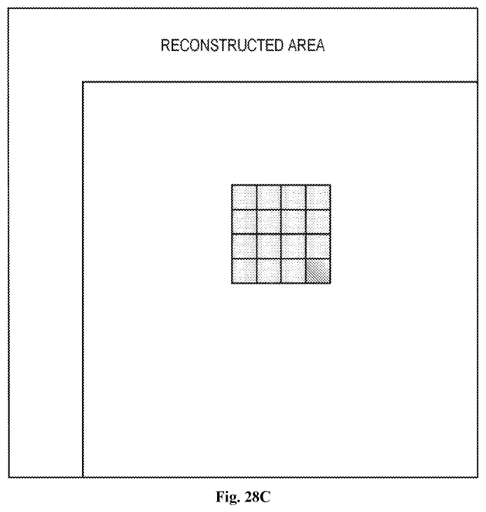

The EIP mode makes predictions for the current block position by position, as shown in FIG. 28A to FIG. 28C. In addition, all inputs to EIP are reconstructed samples in FIG. 28A, partial inputs are reconstructed samples and partial inputs are predicted samples in FIG. 28B, and all inputs to EIP area predicted samples in FIG. 28C.

For the position located at top-left of the current block, the inputs to the EIP filter are reconstructed samples.

For the positions located along the boundaries of the current block, partial inputs to the EIP filter are reference samples, and partial inputs to the EIP filter are previously predicted samples.

For other positions in the current block, the inputs to the EIP filter are previously predicted samples.

To reduce the prediction error, the searched min and max values are applied to restrict the output range of each predicted value,

$${pred}_{( x , y )} = clip ( min , max , ( {\sum }_{i = 0}^{n} ( {c}_{i} \times ( {t}_{( x - xoffset , y - yoffset )} - mean ) ) ) + mean )$$

pred_{(x,y)} is the predicted value at (x, y) in the current block,
min, max are searched min and max values from the thirteen reconstructed columns and rows,
cᵢ is the i^{th} coefficient of the derived EIP filter,
t_{(x-xoffset,y-yoffset)} is reconstructed or predicted value used for the current position's prediction, mean is a value calculated by the DC prediction mode.

### 2.2 InterCCCM

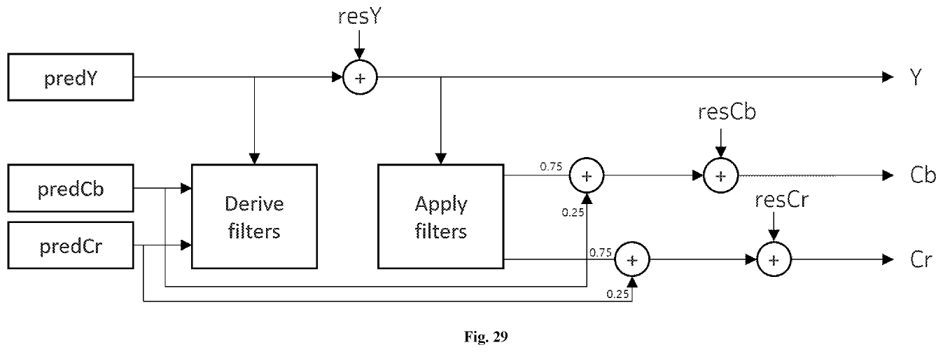

InterCCCM applies the CCCM method for predicting chroma samples from reconstructed luma samples when the CU uses inter prediction or intra block copy (IBC). FIG. 29 illustrates the decoder side of the method. The cross-component filters are derived using the prediction blocks of luma and chroma. The derived filters are applied to the reconstructed luma block and blended with the prediction blocks of chroma to produce the final chroma prediction blocks. In the blending process the filtered reconstructed luma blocks use blending weight of 0.75 and chroma prediction blocks use blending weight of 0.25.

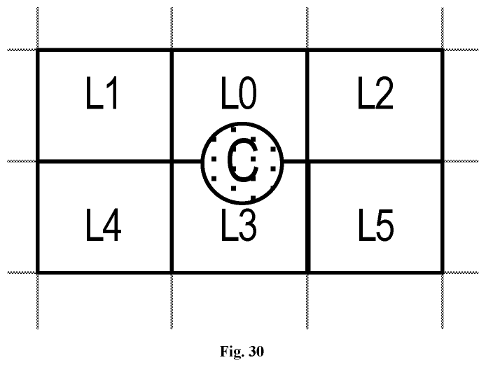

The 8-tap filter consist of 6 spatial luma samples, a nonlinear term, and a bias term. The spatial luma samples (L0, . . . ,L5) are obtained from the luma grid selecting the 6 luma samples closest to the chroma position C without down sampling as shown in FIG. 30. The predicted chroma value is obtained as,

predChromaVal=c₀L0+c₁L1+c₂L2+c₃L3+c₄L4+c₅L5+c₆ nonlinear((L₀+L3+1)>>1)+c₇B,

where nonlinear is CCCM's nonlinear operator and B is bias. The filter coefficients are derived using ECM's division-free Gaussian elimination method and the necessary offsets are applied to samples prior to filter derivation. The offsets for division-free Gaussian elimination method are obtained using a four-point average of the luma and chroma prediction blocks, where the four points correspond to the top-left, top-right, bottom-left and bottom-right corners of the blocks. For filter coefficient derivation at most 256 chroma samples are used.

Usage of the mode is signalled with a CABAC coded TU level flag. One new CABAC context was included to support this. The InterCCCM flag is only signalled if the TU's luma Cbf is non-zero and the CU's predMode is either MODE_INTER or MODE_IBC.

The encoder performs an RD decision in the transform selection loop for the chroma components when luma Cbf is non-zero and the CU's predMode is either MODE_INTER or MODE_IBC.

### 2.3 InterCCP Merge Mode

The intraCCP merge mode is extended to inter coding blocks, where the final chroma inter prediction combines motion-compensation predicted signals and cross-component predicted signals derived using an inherited CCP model from a CCP merge list. A decoder derived intraCCCM candidate is inserted at the front of the interCCP candidate list. In addition to the decoder derived intraCCCM candidate, a set of CCP candidates (i.e. spatial adjacent, temporal, spatial non-adjacent, history-based, shifted temporal, and default candidates) are inherited from previous coded blocks.

### 2.4 Block Vector Guided CCCM

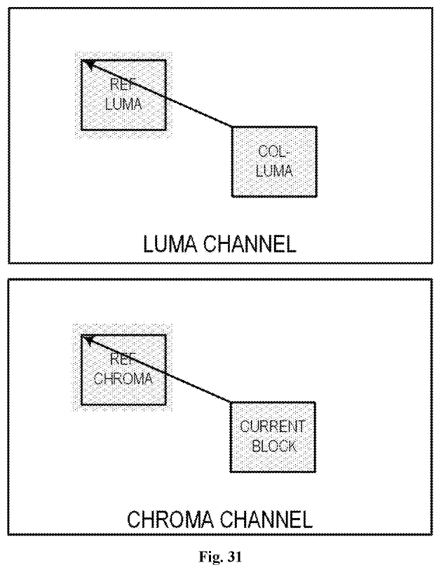

The block vector guided CCCM (BVG-CCCM) method uses block vectors of the co-located luma blocks, coded in IBC or intraTMP modes, to determine the reference area for calculating the CCCM parameters. Then the reference area in luma and corresponding area in chroma channel is used to calculate the CCCM parameters. The prediction uses the calculated model parameters and co-located luma samples to do the CCCM prediction. FIG. 31 illustrates the reference area in BVG-CCCM method.

The mode is enabled only in intra slices. Moreover, an SPS-level flag is introduced for enabling or disabling the mode.

The BVG-CCCM mode uses an 11-tap filter for cross-component prediction as below:

predChromaVal=c₀C+c₁N+c₂S+c₃E+c₄W+c₅P(C)+c₆P(N)+c₇P(S)+c₈P(W)+c₉P(E)+c₁₀B

The input to the spatial 5-tap component of the filter consists of a center (C) luma sample which is collocated with the chroma sample to be predicted and its above/north (N), below/south (S), left/west (W) and right/east (E) neighbors as illustrated in FIG. 32.

The nonlinear term P is represented as power of two of the corresponding luma sample and B is the bias term.

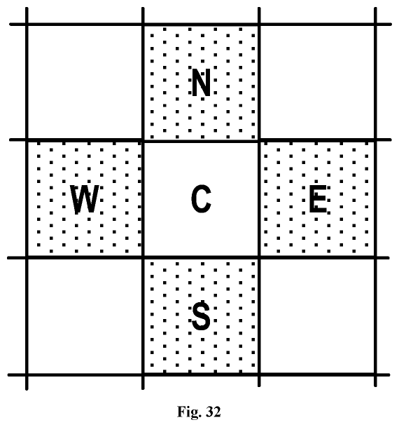

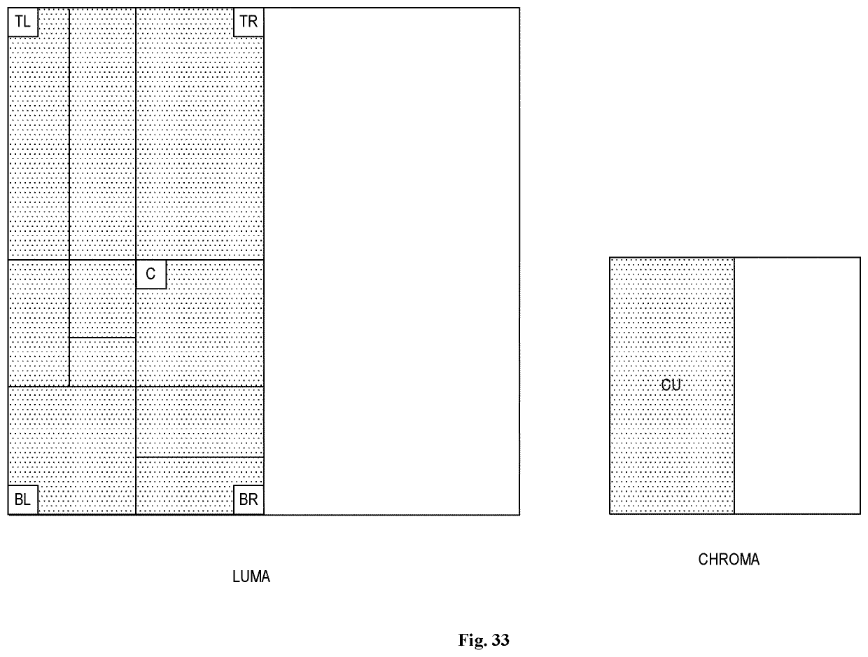

Similar to Direct Block Vector (DBV) mode in ECM-9.0, five locations, as shown in FIG. 33, in collocated luma block area are scanned and the associated block vectors are then used for determining the reference area for parameter calculation in BVG-CCCM method.

The mode can use block vector(s) of both IBC and intraTMP coded blocks from co-located luma area.

### 2.4.1 Bitstream Signalling

Usage of the mode is signalled with a CABAC coded PU level flag. The BVG-CCCM flag is signalled if co-located block is coded in IBC or intraTMP modes and the cross-component index is LM_CHROMA_IDX or MMLM_CHROMA_IDX.

### 2.4.2 Encoder Operation

The encoder performs two additional RD for the BVG-CCCM for single-model and multi-model CCCM variants.

### 3 Problems

Below issues exist in the current ECM and can be improved.
1) In the current ECM, template based reordering is applied to inter/intra CCP merge mode, wherein template cost is derived based on the CCP application. However, how to derive the template cost for a CCP mode can be further improved.
2) In the current ECM, a derived intraCCCM candidate can be inserted to a CCP candidate list of an interCCP merge mode. However, such decoder derived CCP candidates can be further extended for higher compression efficiency.
3) In the current ECM, interCCP mode and interCCPmerge mode can be applied to an inter chroma TB only if there is non-zero luma coefficients. Moreover, interCCPmerge is allowed for inter merge mode but disallowed for AMVP coded blocks. Such design may be improved.

### 4 Detailed Solutions

The detailed embodiments below should be considered as examples to explain general concepts. These embodiments should not be interpreted in a narrow way. Furthermore, these embodiments can be combined in any manner.

The terms “video unit” or “coding unit” or “block” may represent a picture, a slice, a tile, a coding tree block (CTB), a coding tree unit (CTU), a coding block (CB), a CU, a PU, a TU, a PB, or a TB.

The term “prediction unit” may represent a prediction block, or a prediction sample.

The term “CCP” may refer to any cross-component prediction method such as any kind of LM/intraCCLM/interCCCM/MMLM/CCCM/GLM/GL-CCCM/intraCCPmerge/interCCPmerge. It could be used for an intra block, inter block, or IBC block. It could be a type of CCP based fusion mode.

The term “linear/non-linear filter” may refer to a filter/model wherein its coefficients are derived based on a linear regression model or a non-linear model. It could be used for cross-component prediction such as CCP, or same-component prediction such as EFI, filtered IBC, filtered intraTMP, etc.

It is noted that the terminologies mentioned below are not limited to the specific ones defined in existing standards. Any variance of the coding tool is also applicable.
1) A fused template may be used for template cost calculation.
a) The fused template may be used for
   i) Inter-prediction
   ii) Intra-prediction
   iii) IBC prediction
   iv) Any combination of the above.
b) In one example, for a fusion based prediction mode, if template cost is calculated, the predicted template samples may be generated by fusing at least two predictions.
   i) For example, the template samples may be generated by fusing at least two of the followings:
      (1) A CCP model predicted sample value derived by the to-be-accessed CCP model.
      (2) A CCP model predicted sample value derived by a pre-defined CCP mode (e.g., CCCM, CCLM, etc).
      (3) A motion compensated sample value derived by the motion/block vector associated with the to-be-accessed inter mode.
      (4) An intra prediction value derived by the to-be-accessed intra mode.
      (5) An intra prediction value derived by a pre-define intra mode (e.g., DM mode, DIMD mode, or TIMD mode, etc).
   ii) For example, the weights for fusing may be:
      (1) For example, the same weights assignment approach as that used for the derivation for the final prediction of the current prediction block may be used to fuse different parts of the template predictions.
         (a) For example, for interCCCM or interCCPmerge, the weights for template fusion may be M:N (e.g., M=3/4, N=1/4), wherein M for CCP model predicted template value and N for motion compensation predicted template value.
         (b) For example, for CIIP, the weights for template fusion may be M:N (e.g., M=3/4, N=1/4), wherein M for inter motion compensation predicted part and N for intra prediction part.
      (2) Alternatively, different weights assignment approach from that used for the derivation for the final prediction of the current prediction block may be used to fuse different parts of the template predictions.
         (a) For example, a different set of weighting factors may be used for the template fusion process, as compared to the weighting factors used for the derivation for the current prediction block.
      (3) For example, the weights for fusing may be pre-defined fixed values (e.g., block based).
      (4) For example, the weights for fusing may follow a pre-defined rule (e.g., dependent on block width, block height, distance to the block boundary, etc.).
      (5) For example, the weights for fusing may be sample adaptive.
   iii) For example, the fusion based prediction mode may be:
      (1) interCCCM,
      (2) interCCPmerge,
      (3) intraCCPmerge with fusion,
      (4) decoder derived CCP mode with fusion,
      (5) intra chroma prediction with fusion,
      (6) intra luma prediction with fusion,
      (7) CIIP and its variant (e.g., CIIP inter-intra, CIIP IBC-intra, etc.),
      (8) MHP and its variant,
      (9) GPM and its variant (e.g., GPM inter-inter, GPM inter-intra, GPM IBC-intra, GPM IBC-IBC, GPM intra-intra, etc.),
      (10) SGPM and its variant (e.g., SGPM intra-intra, etc.),
      (11) intraTMP fusion,
      (12) IBC with fusion (e.g., bi-predictive IBC, etc).
2) A CCP model may be calculated based on the current block, even if the current block is not CCP coded.
a) The current block must be a chroma block.
b) In one example, a CCP model may be calculated for current intra or inter or IBC block, based on the correlation between luma and chroma components of the prediction of the current block.
   i) For example, the training samples used for computing the model coefficients may be based on the samples inside the current block.
   ii) For example, the training samples used for computing the model coefficients may be based on the samples inside the current block and samples neighboring to the current block.
c) In one example, the calculated CCP model of the current block may be stored in a buffer and used for future block coding.
   i) For example, for a coding block, its CCP model may be derived based on the calculated CCP model of a previous block.
      (1) For example, the coding block may be coded with intraCCPmerge or interCCPmerge or decoderDerivedCCP mode.
      (2) For example, the coding block may be intra or inter or IBC coded.
   ii) For example, a stored calculated CCP model may be tagged with a certain type.
      (1) For example, it may be tagged based on the prediction mode of the block where the CCP model is calculated from.
      (2) For example, for a coding block, which type of calculated CCP models is used may be dependent on the prediction mode of the coding block and the prediction mode of the previous block where the CCP model is calculated from.
   iii) For example, the calculated CCP model may be used for future block coding, regardless of whether the calculated CCP model is calculated from an inter or intra or IBC block.
3) A first prediction derived based on a filter model (e.g., a CCP mode, a linear/non-linear model, etc) may be further fused with a second prediction, to form the final prediction for the current block.
   a) In one example, more than one fusion candidates (e.g., a fusion candidate list) may be generated to derive the second prediction.
      i) For example, which fusion candidate is used may be determined based on template cost.
      ii) For example, which fusion candidate is used may be signalled in the bitstream.
   b) For example, the fusion candidates may be based on:
      i) A CCP mode (e.g., MMLM, MM-CCCM, LBCCP, etc.).
      ii) An intra mode (e.g., DM, Planar, DIMD, TIMD, etc.).
   c) In one example, the current block may be coded with one of the following modes:
      i) intraCCP and/or its variant,
      ii) intraCCPmerge and/or its variant,
      iii) interCCCM and/or its variant,
      iv) interCCPmerge and/or its variant,
      v) decoder derived CCP mode and/or its variant,
      vi) intra chroma prediction and/or its variant,
      vii) intra luma prediction and/or its variant,
      viii) CIIP (e.g., CIIP inter-intra, CIIP IBC-intra, etc.) and/or its variant,
      ix) MHP and/or its variant,
      x) GPM (e.g., GPM inter-inter, GPM inter-intra, GPM IBC-intra, GPM IBC-IBC, GPM intra-intra, etc.) and/or its variant,
      xi) SGPM (e.g., SGPM intra-intra, etc.) and/or its variant,
      xii) intraTMP and/or its variant,
      xiii) IBC (e.g., uni-predictive IBC, bi-predictive IBC, etc.) and/or its variant.
4) A low-pass-filtered CCP candidate may be inserted to a CCP list or a fusion candidate list.
   a) In one example, the low pass filter may be a LBCCP filter.
   b) In one example, an indicator of the low pass filter may be added to a decoder derived candidate (e.g., CCP candidate, intra mode candidate, inter mode candidate, etc.).
      i) For example, a LBCCP flag may be added to a decoder derived multi-model CCP candidate (e.g., intraCCCM, interCCCM, NS-CCCM, GL-CCCM, MDF-CCCM, CCLM, etc.).
         (1) Furthermore, alternatively, it may be added to a decoder derived single-model CCP candidate.
      ii) For example, the generated LBCCP based CCP candidate may be added as an additional CCP candidate in addition to the original decoder derived candidate.
         (1) Alternatively, the generated LBCCP based CCP candidate may be added to replace the original decoder derived CCP candidate.
   c) In one example, an indicator of the low pass filter may be added to an inherited candidate (e.g., CCP candidate, intra mode candidate, inter mode candidate, etc.).
      i) For example, a LBCCP flag may be added to a multi-model inherited CCP candidate (e.g., intraCCCM, interCCCM, NS-CCCM, GL-CCCM, MDF-CCCM, CCLM, etc.).
         (1) Furthermore, alternatively, it may be added to an inherited single-model CCP candidate.
      iii) For example, the generated LBCCP based CCP candidate may be added as an additional CCP candidate in addition to the original non-LBCCP coded CCP candidate.
         (1) Alternatively, the generated LBCCP based CCP candidate may be added to replace the original non-LBCCP coded CCP candidate.
      iii) Furthermore, for example, a non-low-pass-filtered candidate may be generated based on a low-pass-filtered candidate.
         (1) For example, a non-LBCCP candidate (e.g., LBCCP flag equal to false) may be generated wherein the CCP model parameters of the new candidate are inherited from the original LBCCP candidate, but the LBCCP flag is set to false to the new candidate.
         (2) For example, the generated non-LBCCP candidate may be added as an additional CCP candidate in addition to the original LBCCP candidate.
   d) In one example, a CCP candidate list may be constructed based on a first type of candidate and a second type of candidate.
      i) For example, the first type of candidate may be decoder derived candidate (e.g., the CCP model parameters are on-the-fly generated from neighboring reconstructed samples) with LBCCP flag equal to X, and the second type of candidate may have the same CCP model parameters as the first type of candidate but the value of LBCCP flag is equal to (1−X).
         (1) For example, X=0.
      ii) For example, the first type of candidate may be inherited candidate (e.g., the CCP model parameters are inherited from a neighbor CCP coded block) with LBCCP flag equal to Y, and the second type of candidate may have the same CCP model parameters as the first type of candidate but the value of LBCCP flag is equal to (1−Y).
         (1) For example, Y=0.
         (2) For example, Y=1.
   e) In one example, the low-pass-filter may be applied to a single model CCP candidate.
      i) Alternatively, the low-pass-filter may be applied to a multiple model CCP candidate.
   f) In one example, the above mentioned LBCCP filter may refer to another low-pass filter.
5) At most K decoder derived candidates may be inserted to a candidate list (e.g., K>1).
   a) In one example, more than K decoder derived candidates are generated, and K of them may be selected based on a template cost reordering method.
   b) In one example, the K decoder derived candidates may be added to a candidate list containing both decoder derived candidates and inherited candidate.
      i) For example, all candidates in the list may be reordered again for the final coding process.
      ii) For example, all candidates in the list may be reordered for the final coding process.
6) Whether a decoder derived CCP candidate is available for a certain mode may be dependent on:
   a) A high level syntax flag (e.g., sps cccm flag, sps lm flag, sps cclm flag, etc).
   b) A low level syntax flag (e.g., block level ns_cccm flag, etc).
   c) Prediction mode (e.g., LM-TL/L/T mode, MMLM-TL/L/T mode, etc.).
   d) Block coordinates (e.g., the top-left block of the picture may be treated as not having a valid decoder derived CCP candidate).
   e) Block width and/or height.
   f) The number of available neighboring samples within a pre-defined reference region (e.g., if the number of available neighboring samples is less than a pre-defined threshold, it may be treated as not having a valid decoder derived CCP candidate).
7) A first CCP prediction may be fused with a second prediction, wherein the second prediction may or may not be CCP coded.
   a) The second prediction may be interCCP coded.
   b) The second prediction may be intraCCP coded.
   c) The second prediction may be inter coded.
   d) The second prediction may be intra coded.
   e) The second prediction may be IBC coded.
   f) The second prediction may be LBCCP or non-LBCCP coded.
   g) The second prediction may be based on a candidate list comprises at least one (or, a combination of more than one) of the following elements:
      i) a predefined intra mode
      ii) a predefined CCP mode
      iii) a predefined mode table/list
         (1) For example, the predefined mode table/list may include DIMD, and/or TIMD, and/or Planar, and/or MM-CCP, and/or MM-CCCM.
      iv) a CCP candidate list
         (1) For example, both the first CCP prediction and the second CCP prediction may be from a same CCP candidate list.
         (a) For example, how to derive the second CCP prediction may be based on template cost.
         (b) For example, how to derive the second CCP prediction may be determined at encoder and signalled in the bitstream.
         (c) For example, the CCP candidate list may include at least one of the following candidates:
         (i) decoder derived candidate (e.g., the CCP model parameters are on-the-fly generated from neighboring reconstructed samples)
         (ii) inherited candidate (e.g., the CCP model parameters are inherited from a neighbor CCP coded block)
   h) For example, whether the second prediction is from a predefined mode table/list or from the CCP candidate list may be determined at encoder and signalled in the bitstream.
      i) Furthermore, for example, if the second prediction is from a predefined mode table/list, which candidates in the table/list is used may be determined by template cost.
         (1) Alternatively, which candidates in the table/list is used may be further signalled in the bitstream.
      ii) Furthermore, for example, if the second prediction is from the CCP candidate list, which candidates in the list is used may be determined by template cost.
         (1) Alternatively, which candidates in the list is used may be further signalled in the bitstream.
      iii) Alternatively, for example, whether the second prediction is from a predefined mode table/list or from the CCP candidate list may be determined based on decoder side information (such as template cost).
8) For a certain coding unit, at least two fusion modes may be allowed to fuse a first prediction with at least another prediction.
   a) For example, a first syntax may be signalled to indicate whether a first fusion mode is used to the current coding unit, and a second syntax may be signalled to indicate whether a second fusion mode is used.
   b) Alternatively, for example, one syntax (e.g., a fusion mode index) may be signalled to indicate which fusion mode is used to the current coding unit.
   c) For example, the first fusion mode may refer to fuse a CCP candidate A with a CCP candidate B, wherein both A and B are from the same CCP candidate list.
      i) For example, how to determine the CCP candidate A may be based on template cost.
         (1) Alternatively, it may be signalled in the bitstream.
      ii) For example, how to determine the CCP candidate B may be based on template cost.
         (1) Alternatively, it may be signalled in the bitstream.
      iii) For example, the CCP candidate list may include at least one of the following candidates:
         (1) decoder derived candidate (e.g., the CCP model parameters are on-the-fly generated from neighboring reconstructed samples)
         (2) inherited candidate (e.g., the CCP model parameters are inherited from a neighbor CCP coded block)
   d) For example, the second fusion mode may refer to fuse a CCP candidate A with a predefined mode B, wherein B may or may not be CCP coded.
      i) For example, B may be from a pre-defined mode list (such as DIMD, MM-CCCM, etc.)
         (1) For example, which one in the pre-defined mode list is finally selected to derive B may be signalled in the bitstream.
         (2) Alternatively, which one in the pre-defined mode list is finally selected to derive B may be determined based on template cost.
   e) For example, the signalling of the second fusion mode may be signalled conditioned on the first fusion mode.
      i) For example, either the first or the second fusion mode may be applied to the current coding unit.
      ii) For example, if the first fusion mode is used, then the second fusion mode is inferred (e.g., not signalled) to not used to the current coding unit.
   f) For example, both the first fusion mode and the second fusion mode may be applied to the current coding unit.
      i) For example, the two fusion modes may be applied in a cascaded way.
      ii) for example, the signalling of the two fusion modes may not be mutually exclusive.
   g) For example, the above definition of the first fusion mode and the second fusion mode may be swapped.
9) For example, in case a fusion process is to blend an LBCCP coded prediction and a non-LBCCP coded prediction.
   a) For example, the LBCCP flag (e.g., may be equal to 0 or 1) of the first prediction may be stored in the buffer and used for future block's coding.
   b) For example, how to determine the first prediction may be based on template cost.
   c) Alternatively, how to determine the first prediction may be signalled in the bitstream.
      Application of InterCCP or InterCCPmerge when all Zero Luma Coefficients:
10) A CCP based prediction may be generated for the current coding unit, if the luma transform block of the current coding unit contains all zero transform coefficient levels (e.g., luma_cbf==0, or tu_y_coded_flag==0, etc.).
   a) The current coding unit may be:
      i) Inter AMVP based
      ii) IBC AMVP based
      iii) Inter merge based
      iv) IBC merge based
   b) Whether to perform CCP prediction to the current coding unit may be dependent on a syntax element (e.g., a flag).
      i) The syntax element may be signalled at coding unit level such as CU/PU/TU/CB/PB/TB.
      ii) The syntax element may be the same as the one used for the case that the luma transform block contains one or more transform coefficient levels not equal to 0 (e.g., interCCP falg, interCCPmerge flag, intraCCP flag, etc.).
         (1) Alternatively, different syntax elements may be signalled dependent on whether luma transform block contains one or more transform coefficient levels not equal to 0.
         (2) The syntax element may be context coded.
         (a) More than one context model may be used for this syntax element.
         (i) Which context model is used for a certain coding unit may be dependent on whether luma transform block contains one or more transform coefficient levels not equal to 0.
   c) Whether to perform CCP prediction to the current coding unit may be implicitly derived at both encoder and decoder, following a pre-defined rule (i.e., not signalled in the bitstream).
      (1) It may be dependent on previous coding information (e.g., from previous coding units).
         (a) It may be dependent on the CCP mode information of neighboring blocks.
   d) Which CCP model is applied to the current coding unit may be
      i) inherited from a previous CCP coded coding unit.
      ii) on the fly derived/calculated from neighboring (reconstructed) samples.
      iii) derived based on a CCP candidate list containing inherited CCP models and/or on the fly derived/calculated CCP models.
11) A CCP based prediction may be generated for the current coding unit, if the luma transform block and all chroma transform blocks (e.g., Cb transform block and Cr transform block) of the current coding unit contain all zero transform coefficient levels (e.g., rootCbf==0, cu_skip_flag, etc.).
   a) The current coding unit may be:
      i) Inter AMVP based
      ii) IBC AMVP based
      iii) Inter merge based (e.g., inter merge skip mode)
      iv) IBC merge based (e.g., ibc merge skip mode)
   b) Whether to perform CCP prediction to the current coding unit may be dependent on a syntax element (e.g., a flag).
      i) The syntax element may be signalled at coding unit level such as CU/PU.
      ii) The syntax element may be the same as the one used for the case that the luma or chroma transform block contains one or more transform coefficient levels not equal to 0 (e.g., intraCCP flag, intraCCPmerge flag, etc).
         (1) Alternatively, different syntax elements may be signalled dependent on whether luma or chroma transform block contains one or more transform coefficient levels not equal to 0.
         (2) The syntax element may be context coded.
         (a) More than one context model may be used for this syntax element.
         (i) Which context model is used for a certain coding unit may be dependent on whether luma or chroma transform block contains one or more transform coefficient levels not equal to 0.
   c) Whether to perform CCP prediction to the current coding unit may be implicitly derived at both encoder and decoder, following a pre-defined rule (i.e., not signalled in the bitstream).
      (1) It may be dependent on previous coding information (e.g., from previous coding units).
         (a) It may be dependent on the CCP mode information of neighboring blocks.
         (b) For example, if there is at least one of a previously coded block (e.g., at pre-defined positions) is coded with CCP, the current coding unit may be inferred to be coded based on CCP.
      (2) It may be inherited from a previous coding block (e.g., a neighboring block).
         (a) For example, if the merge candidate of such merge skip coded block is CCP coded, then the CCP model associated with such merge candidate is by default used to the current merge skip coded block to generate a CCP based prediction.
         (i) For example, a candidate list is constructed, for both the CCP prediction derivation and motion-compensated prediction derivation.
         (ii) For example, the CCP model (e.g., model parameters, etc.) may be stored associated with each coding unit.
         (iii) For example, the CCP model of a merge candidate may be inherited to the current coding unit.
         (b) Alternatively, if the merge candidate of such merge skip coded block is CCP coded, then the prediction of the current merge skip coded block is by default generated by a CCP model (but the CCP model used to the current merge skip block may be different from the CCP model associated with the merge candidate).
         (i) For example, a new CCP candidate list may be constructed, especially for the CCP prediction derivation.
         1. For example, the inclusion order and/or the rule of CCP list construction may be different from that of the merge list condtruction.
         2. For example, the CCP model parameters may be stored associated with each coding unit and inherited to a future block during the CCP candidate list generation of the future block.
         (ii) For example, an indicator of whether a block is CCP coded (e.g., rather than the CCP model parameters of such block) may be stored associated with each coding unit and inherited to a future block during the merge list generation of the future block.
   d) Which CCP model is applied to the current coding unit may be:
      i) inherited from a previous CCP coded coding unit.
         (1) It could be from the same merge candidate used to generate the motion-compensated prediction of the current block.
         (2) It could be from a CCP candidate especially for the CCP prediction part, which may be different from the merge candidate used to generate the motion-compensated prediction of the current block.
      ii) on the fly derived/calculated from neighboring (reconstructed) samples.
      iii) derived based on a CCP candidate list containing inherited CCP models and/or on the fly derived/calculated CCP models.

### GENERAL ASPECTS

1) The disclosed method may be used in single tree.
2) The disclosed method may be used in dual tree.
3) The disclosed method may be used for chroma coding.
4) The disclosed method may be used for luma coding.
5) The disclosed method may be used for intra block coding.
6) The disclosed method may be used for inter block coding.
7) The disclosed method may be used for IBC block coding.
8) The disclosed method may be used in a inter (such as B or P) slice.
9) The disclosed method may be used in an intra (such as I) slice.
10) Whether to and/or how to apply the disclosed methods above may be signalled at sequence level/group of pictures level/picture level/slice level/tile group level, such as in sequence header/picture header/SPSNPS/DPS/DCI/PPS/APS/slice header/tile group header.
11) Whether to and/or how to apply the disclosed methods above may be signalled at PB/TB/CB/PU/TU/CUNPDU/CTU/CTU row/slice/tile/sub-picture/other kinds of region contain more than one sample or pixel.
12) Whether to and/or how to apply the disclosed methods above may be dependent on coded information, such as block size, colour format, single/dual tree partitioning, colour component, slice/picture type.

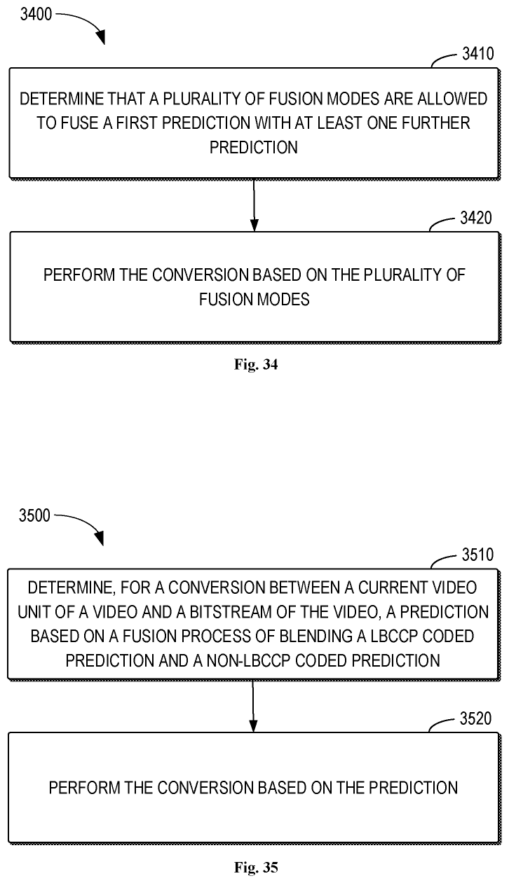

FIG. 34 illustrates a flowchart of a method 3400 for video processing in accordance with embodiments of the present disclosure. The method 3400 is implemented during a conversion between a video unit of a video and a bitstream of the video.

At block 3410, for a conversion between a current video unit of a video and a bitstream of the video, it is determined that a plurality of fusion modes are allowed to fuse a first prediction with at least one further prediction.

At block 3420, the conversion is performed based on the plurality of fusion modes. In some embodiments, the conversion may include encoding the current video unit into the bitstream. Alternatively, the conversion may include decoding the current video unit from the bitstream.

The method 3400 enables the plurality of fusion modes to be allowed. Compared with the conventional solution, the method 3400 advantageously improves the coding efficiency and performance.

In some embodiments, a first syntax may be signalled to indicate whether a first fusion mode is applied to the current video unit, and a second syntax may be signalled to indicate whether a second fusion mode is applied to the current video unit. Alternatively, a third syntax may be signalled to indicate a third fusion mode to be applied to the current video unit. For example, the third syntax may include a fusion mode index.

In some embodiments, a first fusion mode may refer to fusing a first CCP candidate and a second CCP candidate. In this case, both the first CCP candidate and the second CCP candidate are included in a same CCP candidate list. In some embodiments, a way to determine the first CCP candidate may be based on a template cost. In some other embodiments, a way to determine the first CCP candidate may be signalled in the bitstream. In some embodiments, a way to determine the second CCP candidate may be based on a template cost. Alternatively, a way to determine the second CCP candidate may be signalled in the bitstream. In some embodiments, the CCP candidate list may include at least one of: a decoder derived candidate or an inherited candidate. For example, the decoder derived candidate may include a CCP model parameter which is generated in real-time from a neighboring reconstructed sample. Alternatively, the inherited candidate may include a CCP model parameter inherited from a neighbor CCP coded block.

In some embodiments, a second fusion mode may refer to fusing a third CCP candidate and a predetermined mode. In some embodiments, the predetermined mode may be a CCP coded mode. Alternatively, the predetermined mode may not be a CCP coded mode. In some embodiments, the predetermined mode may be from a predetermined mode list. For example, the predetermined mode list may include at least one of: a decoder side intra mode derivation (DIMD) or a multi-model convolutional cross-component model (MM-CCCM). In some embodiments, a mode selected from the predetermined mode list to derive the predetermined mode may be signalled in the bitstream. Alternatively, a mode selected from the predetermined mode list to derive the predetermined mode may be determined based on a template cost.

In some embodiments, a signalling of a second fusion mode may be signalled based on a first fusion mode. Alternatively, a signalling of the first fusion mode may be signalled based on the second fusion mode. In some embodiments, at least one of the first fusion mode or the second fusion mode may be applied to the current video unit. In some embodiments, if the first fusion mode is used, the second fusion mode may be inferred not to be used to the current video unit. For example, the second fusion mode may not be signalled. Alternatively, if the second fusion mode is used, the first fusion mode may be inferred not to be used to the current video unit. For example, the first fusion mode may not be signalled.

In some embodiments, both a first fusion mode and a second fusion mode may be applied to the current video unit. In some embodiments, the first fusion mode and the second fusion mode may be applied in a cascaded way. In some embodiments, a signalling of the first fusion mode may not be exclusive with a signalling of the second fusion mode. In some embodiments, the above definition of the first fusion mode and the second fusion mode may be swapped.

In some embodiments, determining that the plurality of fusion modes are allowed may be used in at least one of: single tree or dual tree. In some other embodiments, determining that the plurality of fusion modes are allowed may be used for at least one of: a chroma coding, a luma coding, an intra block coding, an inter block coding, or an IBC block coding. In some embodiments, determining that the plurality of fusion modes are allowed may be used in an inter slice. For example, the inter slice may be a B slice or a P slice. In some other embodiments, determining that the plurality of fusion modes are allowed may be used in an intra slice. For example, the intra slice may be an I slice.

In some embodiments, an indication of whether to and/or how to determine that the plurality of fusion modes are allowed may be indicated at one of the followings: sequence level, group of pictures level, picture level, slice level, or tile group level. In some other embodiments, an indication of whether to and/or how to determine that the plurality of fusion modes are allowed may be indicated in one of the followings: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to determine that the plurality of fusion modes are allowed may be included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 3400 may further include: determining, based on coded information of the video unit of the video, whether to and/or how to determine that the plurality of fusion modes are allowed. The coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining that a plurality of fusion modes are allowed to fuse a first prediction with at least one further prediction; and generating the bitstream based on the plurality of fusion modes.

According to still further embodiments of the present disclosure, a method for storing bitstream of a video is provided. The method comprises: determining that a plurality of fusion modes are allowed to fuse a first prediction with at least one further prediction; generating the bitstream based on the plurality of fusion modes; and storing the bitstream in a non-transitory computer-readable recording medium.

FIG. 35 illustrates a flowchart of a method 3500 for video processing in accordance with embodiments of the present disclosure. The method 3500 is implemented during a conversion between a video unit of a video and a bitstream of the video.

At block 3510, for a conversion between a current video unit of a video and a bitstream of the video, a prediction is determined based on a fusion process of blending a local-boosting cross-component prediction (LBCCP) coded prediction and a non-LBCCP coded prediction.

At block 3520, the conversion is performed based on the prediction. In some embodiments, the conversion may include encoding the current video unit into the bitstream. Alternatively, the conversion may include decoding the current video unit from the bitstream.

The method 3500 enables the prediction to be determined based on the fusion process of blending the LBCCP coded prediction and the non-LBCCP coded prediction. Compared with the conventional solution, the method 3500 advantageously improves the coding efficiency and performance.

In some embodiments, a LBCCP flag of a first prediction may be stored in a buffer and the LBCCP flag may be used for a coding of a future block. For example, the LBCCP flag may be equal to 0 or 1. In some embodiments, a way to determine a second prediction is based on a template cost. Alternatively, a way to determine a third prediction may be signalled in the bitstream.

In some embodiments, determining the prediction may be used in at least one of: single tree or dual tree. In some other embodiments, determining the prediction may be used for at least one of: a chroma coding, a luma coding, an intra block coding, an inter block coding, or an IBC block coding. In some embodiments, determining the prediction may be used in an inter slice. For example, the inter slice may be a B slice or a P slice. In some other embodiments, determining the prediction may be used in an intra slice. For example, the intra slice may be an I slice.

In some embodiments, an indication of whether to and/or how to determine the prediction may be indicated at one of the followings: sequence level, group of pictures level, picture level, slice level, or tile group level. In some other embodiments, an indication of whether to and/or how to determine the prediction may be indicated in one of the followings: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to determine the prediction may be included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 3500 may further include: determining, based on coded information of the video unit of the video, whether to and/or how to determine the prediction. The coded information may include at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a prediction based on a fusion process of blending a local-boosting cross-component prediction (LBCCP) coded prediction and a non-LBCCP coded prediction; and generating the bitstream based on the prediction.

According to still further embodiments of the present disclosure, a method for storing bitstream of a video is provided. The method comprises: determining a prediction based on a fusion process of blending a local-boosting cross-component prediction (LBCCP) coded prediction and a non-LBCCP coded prediction; generating the bitstream based on the prediction; and storing the bitstream in a non-transitory computer-readable recording medium.

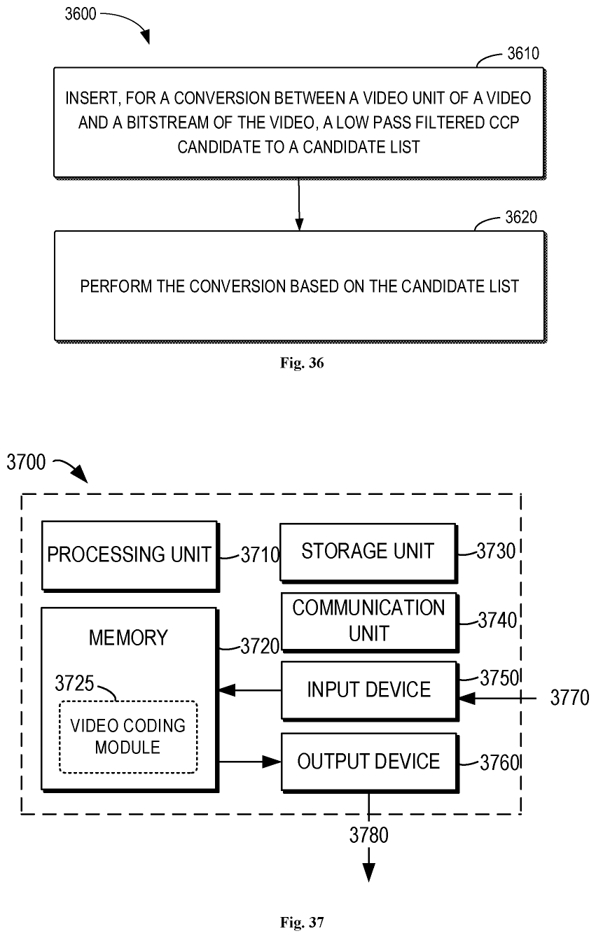

FIG. 36 illustrates a flowchart of a method 3600 for video processing in accordance with embodiments of the present disclosure. The method 3600 is implemented during a conversion between a video unit of a video and a bitstream of the video.

At block 3610, for a conversion between a video unit of a video and a bitstream of the video, a low pass filtered cross-component prediction (CCP) candidate is inserted to a candidate list. In this case, the candidate list is at least one of: a CCP list or a fusion candidate list.

At block 3620, the conversion is performed based on the candidate list. In some embodiments, the conversion may include encoding the video unit into the bitstream. Alternatively, the conversion may include decoding the video unit from the bitstream.

The method 3600 enables the low pass filtered CCP candidate to be inserted to the candidate list. Compared with the conventional solution, the method 3600 advantageously improves the coding efficiency and performance.

In some embodiments, an indication of a low pass filter may be added to an inherited candidate. In some embodiments, the inherited candidate may include at least one of: a CCP candidate, an intra mode candidate, or an inter mode candidate. In some embodiments, a non-low-pass-filtered candidate may be generated based on a low-pass-filtered candidate. For example, a non-LBCCP candidate (e.g., LBCCP flag equal to false) may be generated. In this case, a CCP model parameter of the non-LBCCP candidate may be inherited from a LBCCP candidate, but a LBCCP flag of the non-LBCCP candidate may be set to false. Alternatively, a generated non-LBCCP candidate may be added as an additional CCP candidate in addition to a LBCCP candidate.

In some embodiments, a CCP candidate list may be constructed based on a first type of candidate and a second type of candidate. In some embodiments, the first type of candidate may include a decoder derived candidate (e.g., the CCP model parameters may on-the-fly generated from neighboring reconstructed samples) with a LBCCP flag equal to a first number, and a CCP model parameter of the second type of candidate may be same as that of the first type of candidate, but a value of a LBCCP flag of the second type of candidate may equal to a second number minus the first number. In some embodiments, the first number may equal to 0 and the second number may equal to 1.

In some embodiments, the first type of candidate may include an inherited candidate (e.g., the CCP model parameters may be inherited from a neighbor CCP coded block) with a LBCCP flag equal to a third number, and a CCP model parameter of the second type of candidate may be same as that of the first type of candidate, but a value of a LBCCP flag of the second type of candidate may equal to a fourth number minus the third number. In some embodiments, the third number may equal to 0 or 1, and the fourth number may equal to 1.

In some embodiments, a low pass filter may be applied to a single model CCP candidate. Alternatively, a low pass filter may be applied to a multiple model CCP candidate.

In some embodiments, a fifth number of decoder derived candidates may be inserted to a candidate list. In some embodiments, the fifth number of decoder derived candidates may be added to a candidate list including a decoder derived candidate and an inherited candidate. In some embodiments, candidates in the candidate list may be reordered for a final coding process. In some other embodiments, candidates in the candidate list may be reordered again for a final coding process.

In some embodiments, a first CCP prediction and a second prediction may be fused. In this case, the second prediction may be CCP coded. Alternatively, the second prediction may not be CCP coded. In some embodiments, the second prediction may be a LBCCP coded prediction. Alternatively, the second prediction may be a non-LBCCP coded prediction. In some embodiments, the second prediction may be based on a candidate list including a CCP candidate list. In some embodiments, the second prediction may be a second CCP prediction, and the first CCP prediction and the CCP second prediction may be included in a same CCP candidate list.

In some embodiments, the CCP candidate list may include at least one of: a decoder derived candidate or an inherited candidate. In some embodiments, the decoder derived candidate may include a CCP model parameter which is generated in real-time from a neighboring reconstructed sample. Alternatively, the inherited candidate may include a CCP model parameter inherited from a neighbor CCP coded block.

In some embodiments, inserting the low pass filtered CCP candidate may be used in at least one of: single tree or dual tree. In some other embodiments, inserting the low pass filtered CCP candidate may be used for at least one of: a chroma coding, a luma coding, an intra block coding, an inter block coding, or an IBC block coding. In some embodiments, inserting the low pass filtered CCP candidate may be used in an inter slice. For example, the inter slice may be a B slice or a P slice. In some other embodiments, inserting the low pass filtered CCP candidate may be used in an intra slice. For example, the intra slice may be an I slice.

In some embodiments, an indication of whether to and/or how to insert the low pass filtered CCP candidate may be indicated at one of the followings: sequence level, group of pictures level, picture level, slice level, or tile group level. In some other embodiments, an indication of whether to and/or how to insert the low pass filtered CCP candidate may be indicated in one of the followings: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to insert the low pass filtered CCP candidate may be included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 3600 may further include: determining, based on coded information of the video unit of the video, whether to and/or how to insert the low pass filtered CCP candidate, the coded information including at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: inserting a low pass filtered cross-component prediction (CCP) candidate to a candidate list, wherein the candidate list is at least one of: a CCP list or a fusion candidate list; and generating the bitstream based on the candidate list.

According to still further embodiments of the present disclosure, a method for storing bitstream of a video is provided. The method comprises: inserting a low pass filtered cross-component prediction (CCP) candidate to a candidate list, wherein the candidate list is at least one of: a CCP list or a fusion candidate list; generating the bitstream based on the candidate list; and storing the bitstream in a non-transitory computer-readable recording medium.

Implementations of the present disclosure can be described in view of the following clauses, the features of which can be combined in any reasonable manner.

Clause 1. A method for video processing, comprising: determining, for a conversion between a current video unit of a video and a bitstream of the video, that a plurality of fusion modes are allowed to fuse a first prediction with at least one further prediction; and performing the conversion based on the plurality of fusion modes.

Clause 2. The method of clause 1, wherein a first syntax is signalled to indicate whether a first fusion mode is applied to the current video unit, and a second syntax is signalled to indicate whether a second fusion mode is applied to the current video unit.

Clause 3. The method of clause 1, wherein a third syntax is signalled to indicate a third fusion mode to be applied to the current video unit.

Clause 4. The method of clause 3, wherein the third syntax comprises a fusion mode index.

Clause 5. The method of clause 1, wherein a first fusion mode comprises fusing a first CCP candidate and a second CCP candidate, wherein the first CCP candidate and the second CCP candidate are included in a same CCP candidate list.

Clause 6. The method of clause 5, wherein a way to determine the first CCP candidate is based on a template cost.

Clause 7. The method of clause 5, wherein a way to determine the first CCP candidate is signalled in the bitstream.

Clause 8. The method of clause 5, wherein a way to determine the second CCP candidate is based on a template cost.

Clause 9. The method of clause 5, wherein a way to determine the second CCP candidate is signalled in the bitstream.

Clause 10. The method of clause 5, wherein the CCP candidate list comprises at least one of: a decoder derived candidate or an inherited candidate.

Clause 11. The method of clause 10, wherein the decoder derived candidate comprises a CCP model parameter which is generated in real-time from a neighboring reconstructed sample.

Clause 12. The method of clause 10, wherein the inherited candidate comprises a CCP model parameter inherited from a neighbor CCP coded block.

Clause 13. The method of clause 1, wherein a second fusion mode comprises fusing a third CCP candidate and a predetermined mode.

Clause 14. The method of clause 13, wherein the predetermined mode is a CCP coded mode, or wherein the predetermined mode is not a CCP coded mode.

Clause 15. The method of clause 13, wherein the predetermined mode is from a predetermined mode list.

Clause 16. The method of clause 15, wherein the predetermined mode list comprises at least one of: a decoder side intra mode derivation (DIMD) or a multi-model convolutional cross-component model (MM-CCCM).

Clause 17. The method of clause 15, wherein a mode selected from the predetermined mode list to derive the predetermined mode is signalled in the bitstream.

Clause 18. The method of clause 15, wherein a mode selected from the predetermined mode list to derive the predetermined mode is determined based on a template cost.

Clause 19. The method of clause 1, wherein a signalling of a second fusion mode is signalled based on a first fusion mode, or wherein a signalling of the first fusion mode is signalled based on the second fusion mode.

Clause 20. The method of clause 19, wherein at least one of the first fusion mode or the second fusion mode is applied to the current video unit.

Clause 21. The method of clause 19, wherein if the first fusion mode is used, the second fusion mode is inferred not to be used to the current video unit, or wherein if the second fusion mode is used, the first fusion mode is inferred not to be used to the current video unit.

Clause 22. The method of clause 1, wherein a first fusion mode and a second fusion mode are applied to the current video unit.

Clause 23. The method of clause 22, wherein the first fusion mode and the second fusion mode are applied in a cascaded way.

Clause 24. The method of clause 22, wherein a signalling of the first fusion mode is not exclusive with a signalling of the second fusion mode.

Clause 25. The method of clause 1, wherein determining that the plurality of fusion modes are allowed is used in at least one of: single tree or dual tree.

Clause 26. The method of clause 1, wherein determining that the plurality of fusion modes are allowed is used for at least one of: a chroma coding, a luma coding, an intra block coding, an inter block coding, or an IBC block coding.

Clause 27. The method of clause 1, wherein determining that the plurality of fusion modes are allowed is used in an inter slice.

Clause 28. The method of clause 27, wherein the inter slice is a B slice or a P slice.

Clause 29. The method of clause 1, wherein determining that the plurality of fusion modes are allowed is used in an intra slice.

Clause 30. The method of clause 29, wherein the intra slice is an I slice.

Clause 31. The method of any of clauses 1-30, wherein an indication of whether to and/or how to determine that the plurality of fusion modes are allowed is indicated at one of the followings: sequence level, group of pictures level, picture level, slice level, or tile group level.

Clause 32. The method of any of clauses 1-30, wherein an indication of whether to and/or how to determine that the plurality of fusion modes are allowed is indicated in one of the followings: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 33. The method of any of clauses 1-30, wherein an indication of whether to and/or how to determine that the plurality of fusion modes are allowed is included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 34. The method of any of clauses 1-30, further comprising: determining, based on coded information of the video unit of the video, whether to and/or how to determine that the plurality of fusion modes are allowed, the coded information including at least one of: a block size, a colour format, a single and/or dual tree partitioning, a colour component, a slice type, or a picture type.

Clause 35. A method for video processing, comprising: determining, for a conversion between a current video unit of a video and a bitstream of the video, a prediction based on a fusion process of blending a local-boosting cross-component prediction (LBCCP) coded prediction and a non-LBCCP coded prediction; and performing the conversion based on the prediction.

Clause 36. The method of clause 35, wherein a LBCCP flag of a first prediction is stored in a buffer and the LBCCP flag is used for a coding of a future block.

Clause 37. The method of clause 36, wherein the LBCCP flag is equal to 0 or 1.

Clause 38. The method of clause 35, wherein a way to determine a second prediction is based on a template cost.

Clause 39. The method of clause 36, wherein a way to determine a third prediction is signalled in the bitstream.

Clause 40. The method of clause 35, wherein determining the prediction is used in at least one of: single tree or dual tree.

Clause 41. The method of clause 35, wherein determining the prediction is used for at least one of: a chroma coding, a luma coding, an intra block coding, an inter block coding, or an IBC block coding.

Clause 42. The method of clause 35, wherein determining the prediction is used in an inter slice.

Clause 43. The method of clause 42, wherein the inter slice is a B slice or a P slice.

Clause 44. The method of clause 35, wherein determining the prediction is used in an intra slice.

Clause 45. The method of clause 44, wherein the intra slice is an I slice.

Clause 46. The method of any of clauses 1-45, wherein an indication of whether to and/or how to determine the prediction is indicated at one of the followings: sequence level, group of pictures level, picture level, slice level, or tile group level.

Clause 47. The method of any of clauses 1-45, wherein an indication of whether to and/or how to determine the prediction is indicated in one of the followings: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 48. The method of any of clauses 1-45, wherein an indication of whether to and/or how to determine the prediction is included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 49. The method of any of clauses 1-45, further comprising: determining, based on coded information of the video unit of the video, whether to and/or how to determine the prediction, the coded information including at least one of: a block size, a colour format, a single and/or dual tree partitioning, a colour component, a slice type, or a picture type.

Clause 50. A method for video processing, comprising: inserting, for a conversion between a video unit of a video and a bitstream of the video, a low pass filtered cross-component prediction (CCP) candidate to a candidate list, wherein the candidate list is at least one of: a CCP list or a fusion candidate list; and performing the conversion based on the candidate list.

Clause 51. The method of clause 50, wherein an indication of a low pass filter is added to an inherited candidate.

Clause 52. The method of clause 51, wherein the inherited candidate comprises at least one of: a CCP candidate, an intra mode candidate, or an inter mode candidate.

Clause 53. The method of clause 51, wherein a non-low-pass-filtered candidate is generated based on a low-pass-filtered candidate.

Clause 54. The method of clause 53, wherein a non-LBCCP candidate is generated, wherein a CCP model parameter of the non-LBCCP candidate is inherited from a LBCCP candidate, and a LBCCP flag of the non-LBCCP candidate is set to false.

Clause 55. The method of clause 53, wherein a generated non-LBCCP candidate is added as an additional CCP candidate in addition to a LBCCP candidate.

Clause 56. The method of clause 50, wherein a CCP candidate list is constructed based on a first type of candidate and a second type of candidate.

Clause 57. The method of clause 56, wherein the first type of candidate comprises a decoder derived candidate with a LBCCP flag equal to a first number, and a CCP model parameter of the second type of candidate is same as that of the first type of candidate, a value of a LBCCP flag of the second type of candidate equal to a second number minus the first number.

Clause 58. The method of clause 57, wherein the first number equals to 0 and the second number equals to 1.

Clause 59. The method of clause 56, wherein the first type of candidate comprises an inherited candidate with a LBCCP flag equal to a third number, and a CCP model parameter of the second type of candidate is same as that of the first type of candidate, a value of a LBCCP flag of the second type of candidate equal to a fourth number minus the third number.

Clause 60. The method of clause 59, wherein the third number equals to 0 or 1, and the fourth number equals to 1.

Clause 61. The method of clause 50, wherein a low pass filter is applied to a single model CCP candidate.

Clause 62. The method of clause 50, wherein a low pass filter is applied to a multiple model CCP candidate.

Clause 63. The method of clause 50, wherein a fifth number of decoder derived candidates are inserted to a candidate list.

Clause 64. The method of clause 63, wherein the fifth number of decoder derived candidates are added to a candidate list comprising a decoder derived candidate and an inherited candidate.

Clause 65. The method of clause 64, wherein candidates in the candidate list are reordered for a final coding process.

Clause 66. The method of clause 50, wherein a first CCP prediction and a second prediction are fused, wherein the second prediction is CCP coded or the second prediction is not CCP coded.

Clause 67. The method of clause 66, wherein the second prediction is a LBCCP coded prediction or a non-LBCCP coded prediction.

Clause 68. The method of clause 66, wherein the second prediction is based on a candidate list comprising a CCP candidate list.

Clause 69. The method of clause 68, wherein the second prediction is a second CCP prediction, and the first CCP prediction and the CCP second prediction are included in a same CCP candidate list.

Clause 70. The method of clause 69, wherein the CCP candidate list comprises at least one of: a decoder derived candidate or an inherited candidate.

Clause 71. The method of clause 70, wherein the decoder derived candidate comprises a CCP model parameter which is generated in real-time from a neighboring reconstructed sample.

Clause 72. The method of clause 70, wherein the inherited candidate comprises a CCP model parameter inherited from a neighbor CCP coded block.

Clause 73. The method of clause 50, wherein inserting the low pass filtered CCP candidate is used in at least one of: single tree or dual tree.

Clause 74. The method of clause 50, wherein inserting the low pass filtered CCP candidate is used for at least one of: a chroma coding, a luma coding, an intra block coding, an inter block coding, or an IBC block coding.

Clause 75. The method of clause 50, wherein inserting the low pass filtered CCP candidate is used in an inter slice.

Clause 76. The method of clause 75, wherein the inter slice is a B slice or a P slice.

Clause 77. The method of clause 50, wherein inserting the low pass filtered CCP candidate is used in an intra slice.

Clause 78. The method of clause 77, wherein the intra slice is an I slice.

Clause 79. The method of any of clauses 50-78, wherein an indication of whether to and/or how to insert the low pass filtered CCP candidate is indicated at one of the followings: sequence level, group of pictures level, picture level, slice level, or tile group level.

Clause 80. The method of any of clauses 50-78, wherein an indication of whether to and/or how to insert the low pass filtered CCP candidate is indicated in one of the followings: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 81. The method of any of clauses 50-78, wherein an indication of whether to and/or how to insert the low pass filtered CCP candidate is included in one of the followings: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 82. The method of any of clauses 50-78, further comprising: determining, based on coded information of the video unit of the video, whether to and/or how to insert the low pass filtered CCP candidate, the coded information including at least one of: a block size, a colour format, a single and/or dual tree partitioning, a colour component, a slice type, or a picture type.

Clause 83. The method of any of clauses 1-82, wherein the conversion includes encoding the video unit into the bitstream.

Clause 84. The method of any of clauses 1-82, wherein the conversion includes decoding the video unit from the bitstream.

Clause 85. An apparatus for video processing comprising a processor and a non-transitory memory with instructions thereon, wherein the instructions upon execution by the processor, cause the processor to perform a method in accordance with any of clauses 1-84.

Clause 86. A non-transitory computer-readable storage medium storing instructions that cause a processor to perform a method in accordance with any of clauses 1-84.

Clause 87. A non-transitory computer-readable recording medium storing a bitstream of a video which is generated by a method performed by an apparatus for video processing, wherein the method comprises: determining that a plurality of fusion modes are allowed to fuse a first prediction with at least one further prediction; and generating the bitstream based on the plurality of fusion modes.

Clause 88. A method for storing a bitstream of a video, comprising: determining that a plurality of fusion modes are allowed to fuse a first prediction with at least one further prediction; generating the bitstream based on the plurality of fusion modes; and storing the bitstream in a non-transitory computer-readable recording medium.

Clause 89. A non-transitory computer-readable recording medium storing a bitstream of a video which is generated by a method performed by an apparatus for video processing, wherein the method comprises: determining a prediction based on a fusion process of blending a local-boosting cross-component prediction (LBCCP) coded prediction and a non-LBCCP coded prediction; and generating the bitstream based on the prediction.

Clause 90. A method for storing a bitstream of a video, comprising: determining a prediction based on a fusion process of blending a local-boosting cross-component prediction (LBCCP) coded prediction and a non-LBCCP coded prediction; generating the bitstream based on the prediction; and storing the bitstream in a non-transitory computer-readable recording medium.

Clause 91. A non-transitory computer-readable recording medium storing a bitstream of a video which is generated by a method performed by an apparatus for video processing, wherein the method comprises: inserting a low pass filtered cross-component prediction (CCP) candidate to a candidate list, wherein the candidate list is at least one of: a CCP list or a fusion candidate list; and generating the bitstream based on the candidate list.

Clause 92. A method for storing a bitstream of a video, comprising: inserting a low pass filtered cross-component prediction (CCP) candidate to a candidate list, wherein the candidate list is at least one of: a CCP list or a fusion candidate list; generating the bitstream based on the candidate list; and storing the bitstream in a non-transitory computer-readable recording medium.

### Example Device

FIG. 37 illustrates a block diagram of a computing device 3700 in which various embodiments of the present disclosure can be implemented. The computing device 3700 may be implemented as or included in the source device 110 (or the video encoder 114 or 200) or the destination device 120 (or the video decoder 124 or 300).

It would be appreciated that the computing device 3700 shown in FIG. 37 is merely for purpose of illustration, without suggesting any limitation to the functions and scopes of the embodiments of the present disclosure in any manner.

As shown in FIG. 37, the computing device 3700 includes a general-purpose computing device 3700. The computing device 3700 may at least comprise one or more processors or processing units 3710, a memory 3720, a storage unit 3730, one or more communication units 3740, one or more input devices 3750, and one or more output devices 3760.

In some embodiments, the computing device 3700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3700 can support any type of interface to a user (such as “wearable” circuitry and the like).

The processing unit 3710 may be a physical or virtual processor and can implement various processes based on programs stored in the memory 3720. In a multi-processor system, multiple processing units execute computer executable instructions in parallel so as to improve the parallel processing capability of the computing device 3700. The processing unit 3710 may also be referred to as a central processing unit (CPU), a microprocessor, a controller or a microcontroller.

The computing device 3700 typically includes various computer storage medium. Such medium can be any medium accessible by the computing device 3700, including, but not limited to, volatile and non-volatile medium, or detachable and non-detachable medium. The memory 3720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3730 may be any detachable or non-detachable medium and may include a machine-readable medium such as a memory, flash memory drive, magnetic disk or another other media, which can be used for storing information and/or data and can be accessed in the computing device 3700.

The computing device 3700 may further include additional detachable/non-detachable, volatile/non-volatile memory medium. Although not shown in FIG. 37, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3740 communicates with a further computing device via the communication medium. In addition, the functions of the components in the computing device 3700 can be implemented by a single computing cluster or multiple computing machines that can communicate via communication connections. Therefore, the computing device 3700 can operate in a networked environment using a logical connection with one or more other servers, networked personal computers (PCs) or further general network nodes.

The input device 3750 may be one or more of a variety of input devices, such as a mouse, keyboard, tracking ball, voice-input device, and the like. The output device 3760 may be one or more of a variety of output devices, such as a display, loudspeaker, printer, and the like. By means of the communication unit 3740, the computing device 3700 can further communicate with one or more external devices (not shown) such as the storage devices and display device, with one or more devices enabling the user to interact with the computing device 3700, or any devices (such as a network card, a modem and the like) enabling the computing device 3700 to communicate with one or more other computing devices, if required. Such communication can be performed via input/output (I/O) interfaces (not shown).

In some embodiments, instead of being integrated in a single device, some or all components of the computing device 3700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at aremote location. Alternatively, they may be provided from a conventional server or installed directly or otherwise on a client device.

The computing device 3700 may be used to implement video encoding/decoding in embodiments of the present disclosure. The memory 3720 may include one or more video coding modules 3725 having one or more program instructions. These modules are accessible and executable by the processing unit 3710 to perform the functionalities of the various embodiments described herein.

In the example embodiments of performing video encoding, the input device 3750 may receive video data as an input 3770 to be encoded. The video data may be processed, for example, by the video coding module 3725, to generate an encoded bitstream. The encoded bitstream may be provided via the output device 3760 as an output 3780.

In the example embodiments of performing video decoding, the input device 3750 may receive an encoded bitstream as the input 3770. The encoded bitstream may be processed, for example, by the video coding module 3725, to generate decoded video data. The decoded video data may be provided via the output device 3760 as the output 3780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video unit of a video and a bitstream of the video, that a plurality of fusion modes are allowed to fuse a first prediction with at least one further prediction; and
performing the conversion based on the plurality of fusion modes.

2. The method of claim 1, wherein a first syntax is signalled to indicate whether a first fusion mode is applied to the current video unit, and a second syntax is signalled to indicate whether a second fusion mode is applied to the current video unit, or
wherein a third syntax is signalled to indicate a third fusion mode to be applied to the current video unit.

3. The method of claim 2, wherein the third syntax comprises a fusion mode index.

4. The method of claim 1, wherein a first fusion mode comprises fusing a first cross-component prediction (CCP) candidate and a second CCP candidate, wherein the first CCP candidate and the second CCP candidate are included in a same CCP candidate list, or
wherein a second fusion mode comprises fusing a third CCP candidate and a predetermined mode, or
wherein a signalling of a second fusion mode is signalled based on a first fusion mode, or wherein a signalling of the first fusion mode is signalled based on the second fusion mode.

5. The method of claim 4, wherein a way to determine the first CCP candidate is based on a template cost, or
wherein a way to determine the first CCP candidate is signalled in the bitstream, or
wherein a way to determine the second CCP candidate is based on a template cost, or
wherein a way to determine the second CCP candidate is signalled in the bitstream.

6. The method of claim 4, wherein the CCP candidate list comprises at least one of: a decoder derived candidate or an inherited candidate.

7. The method of claim 6, wherein the decoder derived candidate comprises a CCP model parameter which is generated in real-time from a neighboring reconstructed sample, or
wherein the inherited candidate comprises a CCP model parameter inherited from a neighbor CCP coded block.

8. The method of claim 4, wherein the predetermined mode is a CCP coded mode, or wherein the predetermined mode is not a CCP coded mode, or
wherein the predetermined mode is from a predetermined mode list.

9. The method of claim 8, wherein the predetermined mode list comprises at least one of: a decoder side intra mode derivation (DIMD) or a multi-model convolutional cross-component model (MM-CCCM), or
wherein a mode selected from the predetermined mode list to derive the predetermined mode is signalled in the bitstream, or
a mode selected from the predetermined mode list to derive the predetermined mode is determined based on a template cost.

10. The method of claim 9, wherein at least one of the first fusion mode or the second fusion mode is applied to the current video unit, or
wherein if the first fusion mode is used, the second fusion mode is inferred not to be used to the current video unit, or wherein if the second fusion mode is used, the first fusion mode is inferred not to be used to the current video unit.

11. The method of claim 1, wherein a first fusion mode and a second fusion mode are applied to the current video unit.

12. The method of claim 11, wherein the first fusion mode and the second fusion mode are applied in a cascaded way, or
wherein a signalling of the first fusion mode is not exclusive with a signalling of the second fusion mode.

13. The method of claim 1, wherein a prediction is determined based on a fusion process of blending a local-boosting cross-component prediction (LBCCP) coded prediction and a non-LBCCP coded prediction.

14. The method of claim 13, wherein a LBCCP flag of a first prediction is stored in a buffer and the LBCCP flag is used for a coding of a future block, or
wherein a way to determine a second prediction is based on a template cost, or
wherein a way to determine a second prediction is based on a template cost.

15. The method of claim 14, wherein the LBCCP flag is equal to 0 or 1.

16. The method of claim 1, wherein the conversion includes encoding the current video unit into the bitstream.

17. The method of claim 1, wherein the conversion includes decoding the current video unit from the bitstream.

18. The method of claim 1, wherein the conversion comprises: generating the bitstream from the video, and
the method further comprises: storing the bitstream in a non-transitory computer-readable recording medium.

19. An apparatus for video processing comprising a processor and a non-transitory memory with instructions thereon, wherein the instructions upon execution by the processor, cause the processor to perform acts comprising:
determining, for a conversion between a current video unit of a video and a bitstream of the video, that a plurality of fusion modes are allowed to fuse a first prediction with at least one further prediction; and
performing the conversion based on the plurality of fusion modes.

20. A non-transitory computer-readable storage medium storing instructions that cause a processor to perform acts comprising:
determining, for a conversion between a current video unit of a video and a bitstream of the video, that a plurality of fusion modes are allowed to fuse a first prediction with at least one further prediction; and
performing the conversion based on the plurality of fusion modes.
